(19) United States
(12) Patent Application Publication
(10) Pub. No.: US 2021/0042854 A1
(43) Pub. Date: Feb. 11, 2021

(54) SYSTEM AND METHOD FOR PROVIDING A TECHNOLOGY-SUPPORTED-TRUSTED-PERFORMANCE FEEDBACK AND EXPERIENTIAL LEARNING SYSTEM

(71) Applicant: Forward Impact Enterprises, LLC, Beech Grove, IN (US)

(72) Inventors: James K. Hazy, Lebanon, NJ (US); James Gibbons, Beech Grove, IN (US)

(73) Assignee: Forward Impact Enterprises, LLC, Beech Grove, IN (US)

(21) Appl. No.: 16/988,205

(22) Filed: Aug. 7, 2020

Related U.S. Application Data
(60) Provisional application No. 62/884,877, filed on Aug. 9, 2019.

(51) Int. Cl. G06Q 50/00; H04L 29/08; G06F 21/62

(52) U.S. Cl. CPC G06Q 50/01; G06F 21/6245; H04L 67/306

(57) ABSTRACT

A system for providing trusted performance feedback and experiential learning is disclosed. The system may include receiving, from a first user, feedback related to the effectiveness of a second user relating to participation by the second user in an event. The system may assign the information to avatars of the first and second users. To ensure a user's information remains private to that user, the avatars may be anonymized virtual representations of the first and second users within a virtual social network. Based on an analysis of the information, the system may generate condition state data for the avatars for the first and second users respectively. The condition state data may be time series variables that represent a relationship of the avatars. Based on the condition state data, the system may provide a recommendation or report to the second user for improving the second user's effectiveness at a future event.

This application claims priority to and the benefit of U.S. Provisional Patent Application Ser. No. 62/884,877, filed on Aug. 9, 2019, the entire contents of which are hereby incorporated by reference.

### FIELD OF THE INVENTION

### Field of the Invention

The present application relates to data analysis and feedback technologies, interactive communication technologies, sensor technologies, mobile device technologies, distributed ledger technologies, monitoring technologies, organizational behavior technologies, optimization technologies, machine learning technologies and more particularly, to a system and method for providing technology-supported-trusted-performance feedback and experiential learning, while ensuring that a user's data remains private to that user.

### Background

In today's society, effective team and multiteam system collaborations and interactions are necessary in order to improve and maintain business outcomes, project objectives, and a myriad of other situations involving group interactions. In current work environments, it is difficult for individuals, in particular, but not limited to working level associates, employees or contractors in organization, to get objective, personalized and timely feedback, coaching and mentoring, or to receive and benefit from academic and practical knowledge in a manner that is translated into practical actionable insights relevant to their individual contexts with respect to their perceived contribution and level of engagement after meetings, events or other social interactions in order to improve their management and self-monitoring skills. This is particularly evident in, but not limited to, interactions mediated through or augmented with technology. Furthermore, existing methods of providing and/or generating feedback are not context specific or are not based upon all the relevant data that is available and can be biased. In addition, human interactions are increasingly mediated or augmented with technology and occur over distances with increasing relative frequency. This decreases the availability of social and emotional queues that can be used to build self-monitoring skills and emotional intelligence.

Current approaches for obtaining feedback and improving business outcomes, project objectives, and the like include conducting periodic standardized survey instruments or idiosyncratic and sporadic personal feedback from managers. This issue has been aggravated over recent years by the increasing use of technology-mediated communications. One approach involves using typical human resources surveys, such as 360-degree feedback surveys. Such surveys are distributed only periodically, are general and lack in situation specific context, and the feedback to the individual that comes from them typically has a long time-delay. Also, because these surveys are often used for performance evaluation and pay treatment, they are subject to manipulation and self-serving bias. As another example, feedback from a supervisor or mentor can be idiosyncratic, often riddled with biases, and is received sporadically only when a manager meets with an employee which may be as infrequently as annually or sometimes even less. In these cases, the manager often has very little objective data other than their own personal observation which can be biased by the managers personal history and has access to little or no expert analysis of the little data that is available. In sum, traditional surveys are too infrequent and too general to be actionable because the feedback is difficult to interpret. Likewise, one-on-one feedback is idiosyncratic and based upon limited personal observation which can be biased. Neither of these existing methods solve the issue of promoting timely individual self-awareness regarding one's effectiveness in organized activities such as work or community activities such as meetings and events.

While current technologies and methodologies provide for many benefits and efficiencies, current technologies, still have many shortcomings. In particular, current versions of such technologies often provide limited ways in which to process and analyze feedback so as to improve performance of individuals in a meaningful way over time. Additionally, current technologies do not encourage and promote individuals to provide accurate and honest feedback. Furthermore, current technologies do not provide timely feedback, coaching, and/or mentoring with respect to an individual's perceived contribution and level of engagement after meetings, projects, social gatherings, and/or other interactive situations in order to improve the individual's management and self-monitoring skills. As a result, current methodologies and technologies associated with improving interactions between and/or among individuals and/or devices may be modified and/or enhanced to provide enhanced and optimized feedback for such individuals and/or devices. Such enhancements and improvements to methodologies and technologies may provide for improved team and multiteam system optimization and collaboration, increased privacy, increased compliance with team objectives, reduced incidence of team and/or social interaction failure, reduced costs, and increased ease-of-use.

### SUMMARY

A system and accompanying methods for providing technology-supported-trusted-performance feedback, experiential learning for individuals, and organization state data for analysis and simulation by management are disclosed. In particular, the system and methods provide a software platform that facilitates the obtaining of higher quality feedback, which may be analyzed and enhanced so as to provide reports and/or recommendations to users in order to improve organization's performance as well as the users' performance in interactive situations, such as, but not limited to, team-based projects, multiteam systems, social interactions, working groups at a job, any other interactive situation, or a combination thereof. Notably, the system and methods may include a plurality of components to provide the technology-supported-trusted-performance feedback and experiential learning. In certain embodiments, the system and accompanying methods may include a plurality of parts, which provide the functionality of the system and methods. In particular, the system and methods may include components and subsystems for gathering performance and individual contribution feedback information from users about other users. Based on the gathered performance and feedback information and/or data, the system and methods may include components and subsystems for aggregating and analyzing situational and/or feedback data in an anonymous and secure data environment. Based on the aggregated and analyzed situational and/or feedback data, the system and methods may include components and subsystems that provide a user with the analysis and/or questions to consider as an aid to assist the user's reflective deliberations, and/or, but not limited to advice, coaching services, and/or mentoring services derived from human experts, machine learning algorithms and systems, simulations, and/or artificial intelligence algorithms and/or systems.

In particular, the system and methods may include a Feedforward Subsystem (FFSS), which may be configured to gather, such as from a plurality of users, situational information including, but not limited to, self-assessment data, professional development data, personal or organizational values, goals or objectives, organizational state data, environmental state data, and/or social interaction network structure data. In certain embodiments, the FFSS may also be configured to gather social, emotional intelligence, and/or competency data related to dynamic social interactions and information that influences relationships among individuals that impact individual, team, multiteam systems, or organizational effectiveness as well as content and context specific factors and conditions, before, during, or after meetings, conversations, and/or other events. In addition to the FFSS, the system and methods may include a secure Data Aggregation and Analytics Subsystem (sDAASS), which may be configured to receive data from the FFSS in an anonymous and secure manner in certain embodiments. The sDAASS may be configured, but not limited to, in the context of stored or separately acquired data for either user interfaces (UI) or application programmer interfaces (APIs), to evaluate various scenarios, such as, but not limited to, human or machine simulations, virtual reality (VR), augmented reality (AR), and/or gamified environments (GE), by using various techniques, such as, but not limited to, data analytic techniques (DAT), machine intelligence, such as but not limited to machine learning and artificial intelligence, and/or human expertise (HE) and intelligence.

In addition to the FFSS 302 and the sDAASS 306, the system and methods may include a CoachForward Subsystem (CFSS), which may be configured to determine and recommend appropriate feedback for at least one user. In certain embodiments, the feedback may include coaching or mentoring suggestions to improve performance and may include, but is not limited to, the use of a technology interface, such as, but not limited to, a smartphone, wearable technology, laptop and/or other computer or telecommunication device. In certain embodiments, the feedback may also involve a face to face conversation the contents of which may be provided by the FFSS and/or the sDAASS as discussed herein. The system and methods may further include a secure mapping server (MS). Notably, to ensure confidentiality and to prevent and/or discourage hacking, all data transferred between the various subsystems may be passed through a secure connection and/or processed on the MS 304. In certain embodiments, the MS may be isolated or otherwise secure, however, in other embodiments, the MS may not be isolated, but may still be configured to be secure. In certain embodiments, on the MS, each user in these data including its associations with a plurality of interactions with other users including, but not limited to, a history or prior interactions, may be uniquely identified with a distinct avatar and may be encoded using a secure mapping key (e.g. such as by utilizing blockchain, some other secure ledger, and/or other technique) that is stored, but not limited to, by using secure encryption algorithms. In certain embodiments, the assignment key between user and avatar may remain completely secure and may maintain anonymity, while also allowing various types of data analysis as implemented by human and/or machine processes, as well as the capacity to direct to media, content or coaching advice identified as relevant to an avatar and thus to the relevant live users while maintaining each user's anonymity from every other individual who is not authorized explicitly by the user. The system 100 and methods may further include user interfaces and application programming interfaces that may enable the system and methods to interact and exchange data with third party applications as well.

The system and methods can allow for the following as well. Before, after, or even during an event, the system recognizes that an event of interest is scheduled, is occurring, or is over. This may trigger the system to construct queries specifically relevant to each user who will participate, is participating, or has participated in the event. The system may then send notifications to users who will participate (e.g. notifications may relate to self-assessment, goals, and/or expectations of the event), users who are participating (e.g. notifications may relate to the relevance of agenda items associated with the event), and/or users who have participated in the event with a link to the query. When the user responds to the query, the system gathers this feedback from each individual user about the contributions and engagement of all other users at the event and their perception of the team, multiteam system, organization, and/or its leadership. The system may, but not necessarily then encrypt these data, makes the user's identity anonymous, and erases from the user's devices all user identifying information that is associated with the user-provided-feedback for purposes of anonymity. When and if there are enough responses to guarantee anonymity, the system aggregates these data and may incorporate additional relevant data from other sources including from its own database or is entered by users during scenario analysis. The system then processes these data, analyzes the results to identify relevant patterns, and produces reports. These reports are relayed to managers, analysts, and/or experts, either human, machine or other forms of artificial intelligence to diagnose issues and based upon expert knowledge proposes interventions. The system then sends to each individual user customized data about the analysis of his or her performance. The system can also offer coaching or mentoring advice in the form of suggested article or media, changes to behavior, communications or sentiment, or recommend additional training or knowledge acquisition. This may include previously created and catalogued streaming media, text, photos or videos that are determined to be relevant to the situation. The system may also involve arranging a time for personal one-on-one communications with an expert mentor, whether human or machine, and either anonymous or not. All these methods can be used to improve management and self-monitoring skills.

Notably, the system and methods solve issues associated with existing technologies because individual level data is gathered before, during, and/or after some or many events, if not every event, and includes specific information about the content and context of the event. All data, historical and contextual, is available for analysis to be used to determine individualized feedback about the users' performance at the event soon after every social interaction. Because these data are anonymous and secure, there is no motivation to manipulate these data gathering since it can never be used for performance evaluation or compensation except at the group or organization level. Furthermore, the stored data is itself a source of additional value. The stored data provides a resource for comparing results across organized entities and for learning what works and what does not work in a systematic manner that uses the most advanced data analytics techniques. Over time the system itself will learn how to provide effective coaching and mentoring feedback in many situations. Furthermore, this data set will provide a resource for social science researchers and the system offers possible experimental designs to further knowledge regarding social interactions and organizational effectiveness.

In one embodiment, a system for providing technology-supported-trusted-performance feedback and experiential learning is provided. The system may include a memory that stores instructions and a processor that executes the instructions to perform various operations of the system. The system may perform an operation that includes receiving, from a first user device associated with a first user, information related to the effectiveness of a second user with regard to participation by the second user in an event also participated in by the first user. Additionally, the system may perform an operation that includes assigning the information related to the effectiveness of the second user to a first avatar mapped to a first user identifier of the first user and/or to a second avatar mapped to a second user identifier of the second user. In certain embodiments, the first and second avatars may be anonymized virtual representations of the first user and second users within a virtual social network of the system. Furthermore, the system may perform an operation that includes generating, based on an analysis of the information, first condition state data for the first avatar and second condition state data for the second avatar. In certain embodiments, the first condition state data and the second condition state data may be time series variables for an instance of time or a plurality of instances of time, which may include a representation of a relationship of the first and second avatars to each other in the virtual social network of the system. Moreover, the system may perform an operation that includes providing, based on at least the second condition state data for the second avatar and/or the first condition state data of the first avatar, a report, a recommendation, or a combination thereof, to the second user for improving the effectiveness of the second user with regard to a future event to be participated in by the second user.

In another embodiment, a method for providing a technology-supported-trusted-performance feedback and experiential learning system is provided. The method may include utilizing a memory that stores instructions, and a processor that executes the instructions to perform the various functions of the method. The method may include transmitting a query to a first user device associated with a first user. In certain embodiments, the query requests information related to an effectiveness of a second user with regard to participation by the second user in an event also participated in by the first user. Additionally, the method may include obtaining, from the first user device associated with the first user, the information related to the effectiveness of the second user with regards to participation by the second user in the event also participated in by the first user. Also, the method may include associating the information to a first avatar mapped to a first user identifier of the first user and/or to a second avatar mapped to a second user identifier of the second user. In certain embodiments, the first and second avatars may be anonymized virtual representations of the first user and second users within a virtual social network of the system supporting the functionality of the method. Furthermore, the method may include generating, based on an analysis of the information, first condition state data for the first avatar and second condition state data for the second avatar. In certain embodiments, the first condition state data and the second condition state data may be time series variables for an instance of time or a plurality of instances of time that may represent a relationship of the first and second avatars to each other in the virtual social network of the system. Moreover, the method may include providing, based on at least the first condition state data for the first avatar and/or the second condition state data for the second avatar, a report, a recommendation, or a combination thereof, to the second user for improving the effectiveness of the second user with regard to a future event to be participated in by the second user.

According to yet another embodiment, a computer-readable device having instructions for providing a technology-supported-trusted-performance feedback and experiential learning system is provided. The computer instructions, which when loaded and executed by a processor, may cause the processor to perform operations including: generating a query to a first user device associated with a first user, wherein the query requests information related to an effectiveness of a second user with regard to participation by the second user in an event also participated in by the first user; receiving, from the first user device associated with the first user, the information related to the effectiveness of the second user with regard to participation by the second user in the event also participated in by the first user; associating the information to a first avatar mapped to a first user identifier of the first user, wherein the first avatar is an anonymized virtual representation of the first user within a virtual social network of the system that includes a second avatar mapped to a second user identifier of the second user; providing, based on an analysis of the information, first condition state data for the first avatar and second condition state data for the second avatar, wherein the first condition state data and the second condition state data are time series variables for an instance of time or a plurality of instances of time that may represent, among other things, a relationship of the first and second avatars to each other in the virtual social network of the system; and generating, based on at least the second condition state data for the second avatar, a report, a recommendation, or a combination thereof, for the second user for improving the effectiveness of the second user with regard to a future event to be participated in by the second user.

These and other features of the systems and methods for providing technology-supported-trusted-performance feedback and experiential learning are described in the following detailed description, drawings, and appended claims.

### BRIEF DESCRIPTION OF THE DRAWINGS

FIG. 1 is a schematic diagram of a system for providing technology-supported-trusted-performance feedback and experiential learning according to an embodiment of the present disclosure.

FIG. 2 is a schematic diagram illustrating additional components for supporting the functionality of the system of FIG. 1 according to an embodiment of the present disclosure.

FIG. 3 is a schematic diagram illustrating various subsystems for supporting and providing the functionality of the system of FIG. 1 according to an embodiment of the present disclosure.

FIG. 4 is a flow diagram illustrating a sample method for providing technology-supported-trusted-performance feedback and experiential learning according to an embodiment of the present disclosure.

FIG. 5 is a schematic diagram of a machine in the form of a computer system within which a set of instructions, when executed, may cause the machine to perform any one or more of the methodologies or operations of the systems and methods for technology-supported-trusted-performance feedback and experiential learning.

### DETAILED DESCRIPTION OF THE DRAWINGS

A system 100 and accompanying methods for providing technology-supported-trusted-performance feedback and experiential learning are disclosed. In particular, the system 100 and methods provide a software platform that facilitates the obtaining of high quality feedback, work context information, and/or self-assessment data, which may be analyzed and enhanced so as to provide reports and/or recommendations to users in order to improve the users' performance in interactive situations, such as, but not limited to, team-based projects, multiteam systems, social interactions, working groups at a job, any other interactive situation, or a combination thereof whether physical, in person, and/or virtual. Notably, the system 100 and methods may include a plurality of components to provide the technology-supported-trusted-performance feedback and experiential learning. In certain embodiments, the system 100 and accompanying methods may include a plurality of parts, which provide the functionality of the system 100 and methods. In particular, the system 100 and methods may include components and subsystems for gathering performance and individual contribution feedback information from users about other users. Based on the gathered performance and feedback information and/or data, the system 100 and methods may include components and subsystems for aggregating and analyzing situational and/or feedback data in an anonymous and secure data environment. In certain embodiments, the system and methods may, but not necessarily include, security protocols which may be utilized to separate accounts, processing, charged social and political network analysis, and data management functions for users of aggregated data for the purpose of managing institutions, projects, teams, and events and organization from the data records of those users who create and use the data to give and receive feedback and how this is stored and used to improve their individual contribution in interaction environments. Based on and specifically matched to the condition state identified in the aggregated and analyzed situational, self-assessment, and/or feedback data, the system 100 and methods may include components and subsystems that provide a user with reports or the analysis and/or questions to consider as an aid to assist the user's reflective deliberations, and/or, but not limited to advice, coaching services, and/or mentoring services derived from human experts, machine learning algorithms and systems, and/or artificial intelligence algorithms and/or systems all matched by algorithm or other means to each specific user's individualized needs or interests.

Notably, the system 100 and methods may include gathering, processing, and utilizing social, emotional intelligence, cognitive intelligence, facial expressions, voice or vocal variations, personality, influence, knowledge area breadth and depth, and competency data on individual and group social interactions among individuals that may or may not impact individual, team, and multiteam effectiveness. In certain embodiments, the system 100 and methods may include gathering data on content and context-specific factors and conditions, regarding individual and group performance through a system user interface, biometric interface, and/or application programming interface. The system 100 and methods, such as by utilizing the FFSS 302, may gather this data from a plurality of users through, but not limited to, vote or ranking ballots, surveys, network usage data, surveillance technologies, wearable technology, or other means, during in-person or technology mediated interactions, whether synchronous or asynchronous, such as, but not limited to, meetings, work activities, conversations, and other events. The gathered data may be collected, processed and used using technology mediated communications and computer processing including, but not limited to, a software user interface, telecommunications and database hardware and software, computing and electronic memory. The data then, but not necessarily, may be secured anonymously and may be securely transferred to the sDAASS 306, which may be a secure and anonymous environment for processing, analyzing, simulating, or visualizing that utilizes data analytics, machine intelligence or human expert intervention, or some combination thereof. The analysis conducted by the sDAASS 306 may then be utilized by instructors, researchers, organizational analysts, managers, artificial intelligence or machine learning algorithms to identify and/or simulate potential performance issues and opportunities for improving a user's, team's, multiteam system's or organization's effectiveness and/or performance.

In certain embodiments, based on the processing, the system 100 and methods may select, construct, and/or otherwise determine appropriate and relevant mentoring and coaching content, using, but not limited to, technology such as artificial and machine intelligence, expert systems, social simulation, computer simulation or representation or interactions with a panel of human or machine experts, or a combination thereof. The system 100 and methods, such as by utilizing the CFSS 308, may then select and deliver in-person and/or over a telecommunication network, a description, model, and/or media that proposes suggested behaviors, knowledge acquisition, communications, and/or sentiment intended to improve individual, group, and/or organizational performance. In certain embodiments, the system 100 and methods may enable a user to provide feedback about the usefulness of this content for the user in their situation. Notably, the system 100 and methods provide functionality via a plurality of subsystems that together: 1) gather social, emotional intelligence, self-assessment, self-development, and competency data about, but not limited to, interpersonal or organizational effectiveness; 2) through expert analysis, data analytical and artificial intelligence algorithms identify areas for improvement; and 3) provide context-specific individualized coaching content to a user through a technology interface.

In certain embodiments, based on the processing, the system 100 and methods may facilitate, but are not limited to facilitating interactions that select, construct, and/or otherwise determine user accounts, subscription services, system permissions, available functionality, user access, and other features including, but not limited to, the structure of activities and roles in institutions, industries, functions, departments, projects, teams, and events using, but not limited to, such technology as artificial and machine intelligence, expert systems, social simulation, computer simulation or representation or interactions with a panel of human or machine experts, or a combination thereof. The system 100 and methods, such as by utilizing the Accounts and Plans Subsystem (“A&PSS”) 310, may then select and deliver in-person and/or over a telecommunication network, a description, model, and/or media that describes or proposes suggested roles, institutions, functions, structures, social network structures, projects, teams, individuals, events or other structures or organizing activities. In certain embodiments, the system 100 and methods may enable a user to provide feedback about the effectiveness of these structures for the user in their situation. Notably, the system 100 and methods provide functionality via a plurality of subsystems that together: 1) gather social, emotional intelligence, self-assessment, self-development, and competency data about, but not limited to, interpersonal or organizational effectiveness; 2) through expert analysis, data analytical and artificial intelligence algorithms identify areas for improvement; and 3) provide context-specific individualized coaching content to a user which may but is not limited to where in the organization functions are performed or who has certain responsibilities or authorities, through a technology interface. The system 100 may include security protocols, which separate accounts, processing, network analysis, and data management, for users of aggregated anonymized data for the purpose of managing projects and organization from those users who use the data to receive feedback on or improve their individual contribution in interaction environments; and 4.) situate these activities in an organization's institutional, project, team and other structures.

As indicated elsewhere in the present disclosure, the system 100 and methods may include a plurality of distinct subsystems, which interact with one another, to provide the functionality provided by the system 100 and methods. A first subsystem, the FFSS 302 may comprise a multi-platform user experience (UX) that interfaces with the user through smartphone, tablet, laptop, wearable technology, and broader environmental experiences through the Internet-of-things (IoT), for example, by using surveillance technologies of various types. In certain embodiments, the FFSS 302 may prompt and/or trigger a user's participation by, but not limited to, utilizing queries, such as survey questions or by providing opportunities for “likes”, comments, ranking systems, or audio/video capture or by providing rewards, such as, but not limited, to value units of a cryptocurrency perhaps, but not necessarily, based on underlying blockchain technology, which may, but not necessarily, be unique to the application. In certain embodiments, the user may indicate with a single interaction such as, but not limited to, a click on a digital interface that all participants in the event were helpful and that their participation worked from that user's perspective. In some embodiments, the user response may be given directly from another application such as, but not limited to, a calendar application, text, email, notification of wearable technology or some combination thereof. As another example, a user might be at a meeting or some other event and may be listening to a presentation by a subject matter expert. As the speaker goes through a presentation and/or accompanying media of the presentation, at any point or at many points, the user can swipe up on the user interface of a user device (e.g. such as via a touchscreen) if the material is useful and swipe down if it is unclear or irrelevant. As another example, the user can swipe right if the speaker is engaging and swipe left if the presentation could be improved. In certain embodiments, an opportunity for the user to provide detailed comments that would improve the interaction might also be provided via the system 100 and methods. In certain embodiments, the system 100 may keep track of who is speaking, the expectations with respect to the role of that individual in the meeting or event and where in the presentation the feedback is attached. The tracked information may then transferred to a second subsystem, the sDAASS 306, as feedback for the presenter and for any other users(s) who might be assigned responsibility for the meeting, an agenda item, presentation, report, event, project or objective associated with the event. The transfer of the tracked information to the sDAASS 306 may occur securely and anonymously, such as, but not limited to, by utilizing encryption at both ends. In certain embodiments information from the A&PSS 310 may be integrated into the sDAASS 306. In certain embodiments, information from prior events may also be analyzed to provide pre-event briefings for users.

In certain embodiments, in order to ensure confidentiality and prevent or discourage hacking, all data in FFSS 306 related to any particular user's interactions and relating to other users may be passed first anonymously through a secure connection to a separate secure MS 304, where each user that is identified in the data that is associated with interactions with other users is uniquely identified with a distinct avatar. This identification user-to-avatar may be encoded using a secure mapping key and/or secure token (such as by utilizing blockchain or some other secure ledger) that is securely stored. In certain embodiments, the assignment key may be utilized to associate analysis and content relevant to the avatar back to a live user. This may allow another third subsystem, the CFSS 308, to access coaching media and resources that are specific and contextually relevant to a given user's needs and interests at a point in time and this may be done securely. In certain embodiments information from the A&PSS 310 may be securely integrated into the CFSS 308 to access coaching media and resources that are specific and contextually relevant to a given user's needs and interests at a point in time.

Notably, the sDAASS 306 may serve as the analytical and cognitive core for the system 100 and methods. As a standalone system, the sDAASS 306 is both secure and completely anonymous in certain embodiments. All users may be securely represented as avatars in the system 100 and methods. Avatars in the sDAASS 306 may be associated with one another and with events, meetings, projects, multiteam systems, objectives and organizations in what amounts to a dynamic virtual representation of the universe of interactions of all users of the system 100 and methods. Each avatar (and thus through secure indexing, each live user) may have a secure and unique window into the virtual social network universe as that interaction network impacts the user. Each avatar may be assigned a time series tensor variable called condition state, which represents the avatar user's universe as experienced from the perspective of each unique avatar. Feedback from users may be transferred securely into the virtual universe and aggregated in the context of avatars to insure anonymity, and such data may be compiled and analyzed to provide specific and targeted feedback to each user through its avatar. For analytical purposes, condition states may be projected onto a smaller space of condition-state-types and/or categories. In certain embodiments, feedback is developed for each condition-state-type and each avatar that is assigned a particular condition-state-type receives similar feedback. In certain embodiments, the feedback may be sent to CFSS 308 indexed by this condition-state-type that may, but not necessarily, include, status or reputation rank data with respect to others in the focal avatar's virtual network. Thus, the system 100 and methods allow each user to have secure access to a secure virtual and otherwise anonymous representation of its personal social, knowledge and resource networks, as well as historical events and operational context for purposes of exploration and simulation scenarios. Independently, the condition-state-type or category for a given avatar may be sent to the CFSS 308 and may then be securely mapped to the user as that user's interest-state and/or code. In certain embodiments, information from the A&PSS 310 may be integrated into the CFSS 308 to access coaching media and resources that are specific and contextually relevant to a given user's needs and interests at a point in time and this may be done securely. In certain embodiments, no personal or demographic identification information about users is contained in the sDAASS 306.

In certain embodiments, a first avatar's condition-state may, but not necessarily, be calculated using information gathered from self-assessment and self-development activities, organization-state and environment-state data together with the survey responses and other input about the first avatar by others avatars (reflecting other users), considered both individually and in the aggregate as for scenarios that have similar characteristics, to survey questions about specific events, series of events, event types, projects or collection of projects, or the roles taken by the first avatar is any of the above. This condition-state, perhaps but not necessarily in combination with other conditions states, may then be mapped into a condition-state-type by an algorithm which associates distinct condition-states with statistically or otherwise similar data characteristics into an equivalence category for the purpose of simplifying analysis. The foregoing results in the first avatar being assigned a condition-state-type for each condition-state that is calculated. In certain embodiments, an avatar may have many condition-state types.

In certain embodiments, the CFSS 308 may exist for the purpose of generating a news and resources feed for the user that is personalized to include situational context of a plurality of types. For example, situational context may include feedback from others regarding personal effectiveness during recent and historical events to enable reflection and promote self-awareness regarding one's personal situation and effectiveness and if desired to establish personal development targets. As another example, situational context may include upcoming events previously identified to the system 100 to prepare the user to be as effective as practicable by providing relevant information and context regarding the social interaction, relative influence, and subject matter expertise of various participants. As a further example, situational context may include progress toward the user's personalized longer-term goals and objectives. In certain embodiments, the content available to the user may include: articles and media of various types, background and personal interaction history on individuals with whom the user will be interacting during upcoming events, targeted training opportunities such as tutorials, interactive instructor involved experiences, simulations including virtual reality and/or augmented reality environments, gamified interaction tools, holograms, and opportunities for one-on-one coaching involving either machine or human experts or some combination of both. In certain embodiments, the user may receive reports reflecting responses from other users which may include, but are not limited to, aggregated data, historical data, comparative data, statistical data, or compiled from textual comments compiled and otherwise.

In certain embodiments, the content made available for users may, but not necessarily, be curated in a manner that abstracts, translates technical or academic articles, or otherwise references or links published, pre-published, training program materials, training course materials, training assessment materials, open access, or other previously available information identified inside the system or beyond the system, for example, but not limited to, on the Internet. In certain embodiments this material may qualified as all of part of but is not limited to a certification program for example but not limited to a Certified Financial Analysis (CFA) certificate, an accredited academic degree program such as but not limited to an Masters in Business Administration (MBA) program, or and professional licensing program, such as but not limited to a becoming licensed real estate agent, electrician, investment advisor and so forth. In certain embodiments, the content may be proprietary for a particular account or accounts and available only to users with appropriate permissions. The curation could involve but is not limited to sentient analysis of freeform comments or other information gathered from other users that is made anonymous through artificial intelligence and machine learning algorithms. The curation could involve, but is not limited to, human experts, machine experts, algorithms, machine learning, artificial intelligence, voting systems, user liking or ranking system, randomly selected or otherwise gathered. In certain embodiments the results can be presented using hologram or other representation technology.

In certain embodiments, the situational context a first user may experience can be classified as a User-Interest and each of these may be assigned a User-Interest-Code. As an example, this may include but is not limited to motivation for self-improvement in some aspect of professional development as identified in a self-assessment survey or from the user's professional development plan, or it may involve but is not limited to a user's recognition, due to feedback, of a need for the user to improve for example public speaking skills. In certain embodiments, the professional development plan may include but is not limited to the individual progressive development of a portfolio of skills, behaviors or competencies, such as but not limited to those that might be signified as one or more of the categories Expert Contributor, Agile Contribution, Organizing Contributor, or Authentic Contributor or a combination thereof, to one or more of but not limited to Autonomous Contributor or Collaborative Contributor or a combination there of, and then to a single portfolio that might be called, but is but not limited to, Transformational Contributor. In certain embodiments, a User-Interest-Code can be inferred by the system 100, by experts, through artificial intelligence or through machine learning algorithms and assigned to the first user for the purpose of identifying the coaching or media content or translated scholarly or practical research or material, to be pushed to the user by the system. In certain embodiments, pushed content might include comparison with but not limited to benchmarks, other team scores, other individual scores along with but not necessarily awards, accommodations, points or other reward whether monetary or otherwise. In certain embodiments, these can be determined in a secure manner for the first user by mapping the condition-state-type of the User's associated avatar to a User-Interest code and assigning it to the first User. In certain embodiments augmented reality or hologram technology could be used to bring experts to individuals for virtual coaching sessions. In certain user embodiments the user who receives feedback may thank those providing feedback or but not necessarily comments of feedback either anonymously or personally and either to individuals or to all participants by interacting with the system.

In certain embodiments, the content pushed to the user via the CFSS 308 may be selected based on coded messages that together describe the user's time-stamped condition-state which in the context of the CFSS 308 may be called the user's “interest-state-at-time-t”. Once content is accessed and pushed to the user, the value of the user's interest-state-at-time-t may be encrypted and stored within the CFSS 308, along with content access history for use only by the user if the user chooses to access it. [Note: In certain embodiments, all condition state information may only be retained in anonymous form in the sDAASS 306 as part of the virtual history of the user's secure and uniquely assigned avatar. For example, this may be used to inform future analysis and condition state assignments.] In order to ensure confidentiality and prevent hacking, the condition-state in sDAASS 306 for a particular avatar may be passed anonymously through secure connection from the sDAASS 306 to a separate secure MS 304, where the user associated with the avatar may be identified and assigned an interest-state-at-time-t (i.e., its avatar's condition-state-at-time-t). The user's interest-state-at-time-t may then be attached to a user identifier and securely sent to the CFSS 308. This key may be sent to access coaching media and resources relevant to the user's interest-state-at-time-t.

In certain embodiments, the content or media that has been pushed to a user based upon on the user's User-Interest-Code may be pushed to that user in the context of augmented reality (AR) or virtual reality (VR) technology or hologram technology, perhaps but not necessarily as a tactile signal such as but not limited to vibration, an audio signal such as but not limited to a tone, series of tones, or combination of tones, olfactory signal such as but not limited to a taste or smell, or as a visual signal such as a color or image, series of colors or images, or a combination of colors and images including but not limited to computer generated images such as but note limited vector graphic rendered images common in online gaming, or any combination of these as signaled by but not limited to wearable technology, such that it can be but is not limited to being delivered in the context of a training exercise, simulation exercise, or an actual situation or event. This could occur but is not limited to cases where the actual situation or event is calculated to correspond to an event that resulted in the condition-state-type for the user's avatar from which the system identified the first user's User Interest-Code. This can be offered by the system as a reminder, trigger or warning signal regarding coming of a situation or the execution of a recommended activity or behavior as way to prevent the recurrence of the undesirable Condition-State-Type or promote the occurrence of a desirable Condition-State-Type. In certain embodiments the system may receive direct feedback from an individual or aggregated feedback to determine a operational concern or opportunity for example but not limited to a project deliverable being delayed or an unresolved conflict on the team that may or may not need to be addressed by an individual, subset of individuals, the team, or the organization. In certain embodiments, information from the A&PSS 310 may be securely integrated into the CFSS 308 to access coaching media and resources that are specific and contextually relevant to a given user's needs and interests at a point in time.

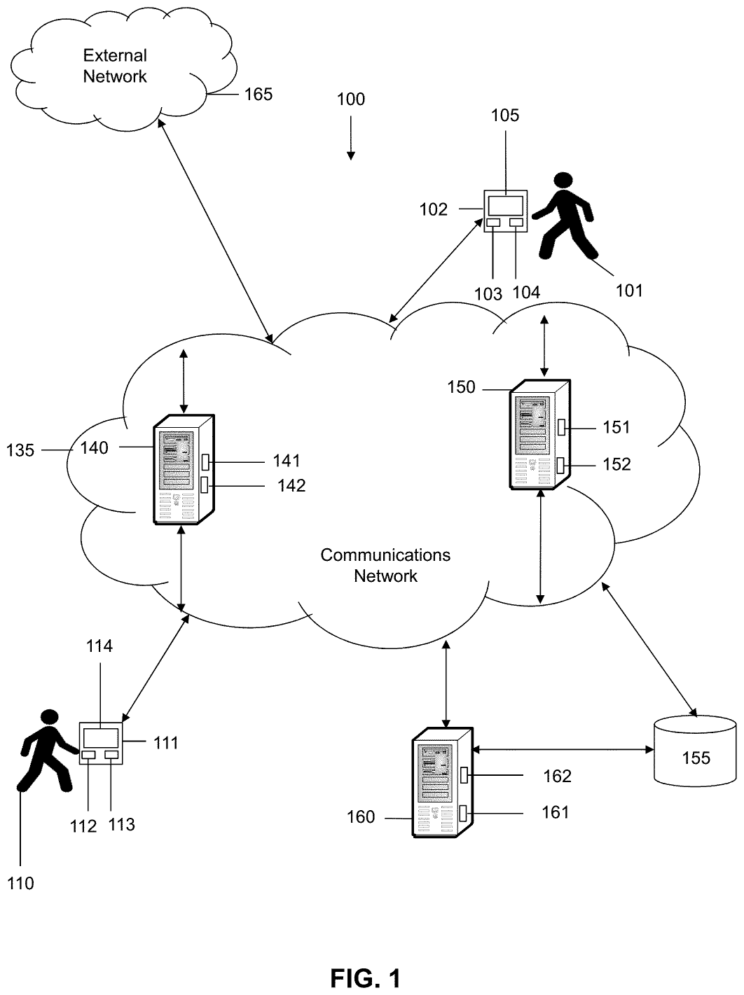

As shown in FIG. 1, a system 100 for providing technology-supported-trusted-performance feedback is disclosed. The system 100 may be configured to support, but is not limited to supporting, project-collaboration services, event scheduling services, project or event staffing services, role assignment services, elections for roles or offices, deliverable assignment services, team and multiteam system organizing services, interactive services, project optimization services, feedback services, self-assessment services, professional or other self-development services, content delivery services, surveillance and monitoring services, cloud computing services, satellite services, telephone services, voice-over-internet protocol services (VoIP), software as a service (SaaS) applications, platform as a service (PaaS) applications, gaming applications and services, social media applications and services, operations management applications and services, productivity applications and services, mobile applications and services, and any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. In certain embodiments, the first user 101 may be an individual that may interact with others (e.g. second user 110) at an event or activity, such as but not limited to, a social gathering, a work meeting, a political campaign, or experience, a team or multiteam system project, a performance of an activity (e.g. sports, acting, workout, and/or any type of activity), a social networking gathering, any type of socially-interactive activity, or any combination thereof. In certain embodiments, the first user 101 may be a robot, a computer, a program, a process, a humanoid, an animal, any type of user, or any combination thereof. The first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, and/or any other type of computing device. Illustratively, the first user device 102 is shown as a smartphone device in FIG. 1.

In addition to using first user device 102, the first user 101 may also utilize and/or have access to additional user devices. As with first user device 102, the first user 101 may utilize the additional user devices to transmit signals to access various online services and content. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the additional user devices may be and/or may include a computer, any type of sensor, a laptop, a set-top-box, a tablet device, a phablet, a server, a mobile device, a smartphone, a smart watch, and/or any other type of computing device whether wearable, implanted, or otherwise, and/or any combination thereof.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing Bluetooth Low Energy (BLE), classic Bluetooth, ZigBee, cellular, NFC, Wi-Fi, Z-Wave, ANT+, IEEE 802.15.4, IEEE 802.22, infrared, RFID, Wireless HD, Wireless USB, any other protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information relating to the various components of the user devices, information identifying the locations of the user devices, information indicating the types of sensors that are contained in and/or on the user devices, information indicating biometric information for identifying any user associated with the user devices, 110, information indicating authentication information associated with any user associated with the user devices, information identifying the types of connections utilized by the user devices, information identifying the applications being utilized on the user devices, information identifying how the user devices are being utilized by a user, information identifying whether the user devices are moving, information identifying an orientation of the user devices, information identifying which user is logged into and/or using the user devices, information identifying user profiles for users of the user devices, information identifying device profiles for the user devices, information identifying the number of devices in the communications network, information identifying devices being added to or removed from the communications network, any other information, or any combination thereof.

Information obtained from the sensors of the user devices may include, but is not limited to, biometric information from any biometric sensor (or other sensor) of the user devices, heart rate information from heart sensors the user devices, temperature readings from temperature sensors of the user devices, ambient light measurements from light sensors of the user devices, sound measurements from sound sensors of the user devices, global positioning information from global positioning devices of the user devices, proximity information from proximity sensors of the user devices, motion information from motion sensors of the user devices, presence information from presence sensors of the user devices, orientation information from gyroscopes of the user devices, orientation information from orientation sensors of the user devices, acceleration information from accelerometers of the user devices, information from any other sensors, or any combination thereof. In certain embodiments, information from the sensors of the first user device 102, additional user devices, and/or second user device 111 may be transmitted via one or more signals to each other and to the components of the system 100.

In addition to the first user 101, the system 100 may also include a second user 110, who may utilize a second user device 111 to perform a variety of functions. For example, the second user device 111 may be utilized by the second user 110 to transmit signals to request various types of content, services, and data provided by content and service providers associated with the communications network 135 or any other network in the system 100. In certain embodiments, the second user 110 may be an individual that may interact with others (e.g. first user 101) at an event, such as but not limited to, a social gathering, a work meeting, a team project, a performance of an activity, a social networking gathering, any type of socially-interactive activity, or any combination thereof. In certain embodiments, the second user 110 may be a manager, administrator, and/or other individual that may monitor and/or supervise the interactions conducted by the first user 101 during various events. In further embodiments, the second user 110 may be a robot, a computer, a program, a process, a humanoid, an animal, any type of user, or any combination thereof. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the second user 110 to interact with various applications executing on the second user device 111 and to interact with the system 100. In certain embodiments, the second user device 111 may be a computer, a laptop, a set-top-box, a tablet device, a phablet, a server, a mobile device, a smartphone, a smart watch, and/or any other type of computing device whether wearable, implanted, or otherwise. Illustratively, the second user device 111 is shown as a smartphone device in FIG. 1.

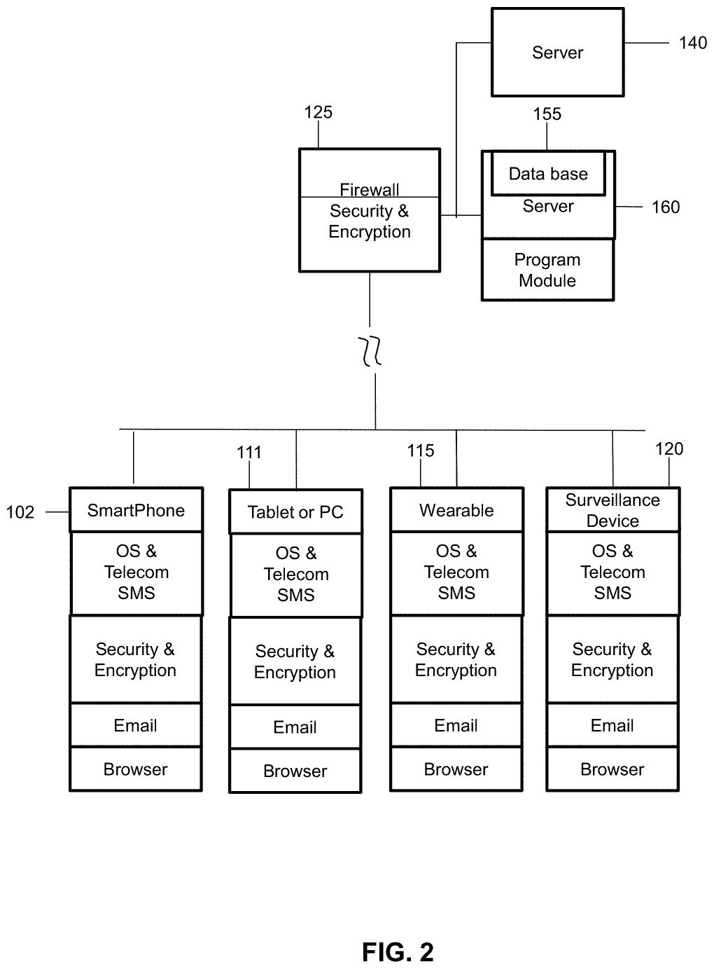

The system 100 may also include a third user device 115, which may be utilized by users of the system 100. The third user device 115 may include a memory that includes instructions, and a processor that executes the instructions from the memory to perform the various operations that are performed by the third user device 115. In certain embodiments, the processor may be hardware, software, or a combination thereof. The third user device 115 may also include an interface (e.g. screen, monitor, graphical user interface, etc.) that may enable the third user device 115 to interact with various applications executing on the third user device 115 and to interact with the system 100. In certain embodiments, the third user device 115 may be a computer, a laptop, a set-top-box, a tablet device, a phablet, a server, a mobile device, a smartphone, a smart watch, and/or any other type of computing device whether wearable, implanted, or otherwise. Illustratively, the third user device 115 is shown as a wearable device in FIG. 2. The system 100 may also include a computing device 120, which may be utilized to monitor the users, such as during an event. The computing device 120 may include a memory that includes instructions, and a processor that executes the instructions from the memory to perform the various operations that are performed by the computing device 120. In certain embodiments, the processor may be hardware, software, or a combination thereof. The computing device 120 may also include an interface (e.g. screen, monitor, graphical user interface, etc.) that may enable the computing device 120 to interact with various applications executing on the computing device 120 and to interact with the system 100. In certain embodiments, the computing device 120 may be a computer, a monitoring device, a camera, a motion detector, any type of sensor, a laptop, a set-top-box, a tablet device, a phablet, a server, a mobile device, a smartphone, a smart watch, and/or any other type of computing device whether wearable, implanted, or otherwise. Illustratively, the computing device 120 is shown as a surveillance device in FIG. 2. Notably, any of the user devices of the system 100 may include operating systems, telecommunications capabilities (SMS, calls, etc.), security and encryption functionality for securing data, email functionality, browser functionality, and/or any other functionality. The system 100 may also include a firewall 125, which may be designed to block unauthorized access of data of the system 100, devices of the system 100, programs of the system 100, or any combination thereof. The firewall 125 may also allow the devices and/or programs of the system 100 to communicate securely with external network 165. In certain embodiments, the firewall 125 may be configured to provide security for the data and processes conducted by the system 100 and/or may be utilized encrypt data and/or information traversing various components, devices, and/or programs of the system 100.

In certain embodiments, the first user device 102, the additional user devices, and/or the second user device 111 (and/or third user device 115 and/or computing device 120) may have any number of software applications and/or application services stored and/or accessible thereon. For example, the first user device 102, the additional user devices, and/or the second user device 111 may include feedback applications, collaborative-work applications, voting applications, interactive social media applications, biometric applications, cloud-based applications, Von′ applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces to enable the first and second users 101, 110 to readily interact with the software applications. The software applications and services may also be utilized by the first and second users 101, 110 to interact with any device in the system 100, any network in the system 100, or any combination thereof. In certain embodiments, the first user device 102, the additional user devices, and/or the second user device 111 may include associated telephone numbers, device identities, or any other identifiers to uniquely identify the first user device 102, the additional user devices, and/or the second user device 111.

The system 100 may also include a communications network 135. The communications network 135 may be under the control of a service provider, the first user 101, the second user 110, any other designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or be connected to a processor and memory to perform the various operation associated with the database 155. In certain embodiments, the database 155 may be connected to the firewall 125, the servers 140, 145, 150, 160, the first user device 102, the second user device 111, the additional user devices, the third user device 115, the computing device 120, any devices in the system 100, any process of the system 100, any program of the system 100, any other device, any network, or any combination thereof.

The database 155 may also store information and metadata obtained from the system 100, store metadata and other information associated with the first and second users 101, 110, store user profiles associated with the first and second users 101, 110, store device profiles associated with any device in the system 100, store communications traversing the system 100, store user preferences, store information associated with any device or signal in the system 100, store information relating to patterns of usage relating to the user devices 102, 111, 115 and/or computing device 120, store any information obtained from any of the networks in the system 100, store any biometric information obtained from any of the sensors of the system 100, store biometric and/or digital credentials, store historical data associated with the first and second users 101, 110, store device characteristics, store information relating to any devices associated with the first and second users 101, 110, store any information associated with the computing device 120, store authentication information, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

The system 100 may also include an external network 165. The external network 165 may be under the control of a different service provider than communications network 135, any designated user, a computer, another network, or a combination thereof. The external network 165 of the system 100 may be configured to communicate with communications network 135. For example, the communications network 135 may be utilized to communicate with the first user device 102 and to connect with other devices within or outside external network 165. Additionally, the external network 165 may be configured to transmit, generate, and receive any information and data traversing the system 100. In certain embodiments, the external network 165 may include any number of servers, databases, or other componentry. The external network 165 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. In certain embodiments, the external network 165 may be part of a single autonomous system that is located in a particular geographic region, or be part of multiple autonomous systems that span several geographic regions.

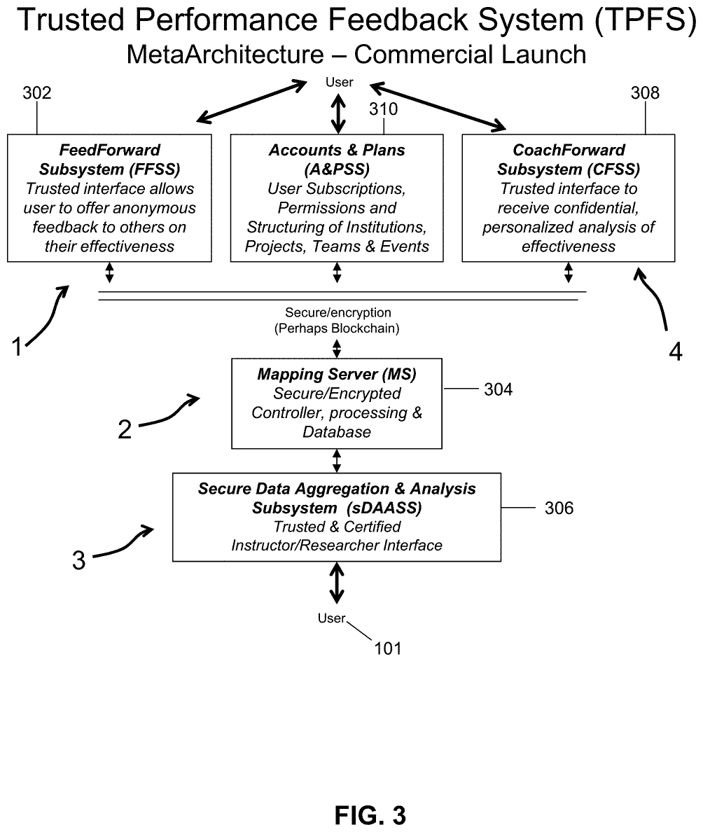

Notably, in certain embodiments and as shown in FIG. 3, the system 100 may include a FFSS 302. The FFSS 302 may be a subsystem of the system 100 that is a technology-supported user-experience and interaction platform, which may enable users to provide and receive feedback about the perceived competence, effectiveness, and/or performance of others with whom the interact, such as at an event. In certain embodiments, the FFSS 302 may include software, hardware, or a combination of software and hardware. In certain embodiments, the FFSS 302 may reside on the first and/or second user devices 102, 111, the third user device 115, the servers 140, 150, 160, the communications network 135, the computing device 120, the external network 165, any other devices, systems, and/or locations, or a combination thereof. In certain embodiments, the FFSS 302 may include any number of servers, interfaces, sensors, devices, programs, modules, or a combination thereof, to facilitate the performance and functionality of the FFSS 302. In certain embodiments, the FFSS 302 may be configured to schedule events and meetings for any number of users. Social interactions and emotional reactions that occur within each event may form the basis for responses to systems queries. In certain embodiments, the FFSS 302 may gather information about an institution's and/or organization's state (e.g. an entity that the user works for, for example) and about the environment's state (e.g. the state of the location at which the event is occurring). In certain embodiments, these data may be obtained by interfacing with other entities, such as, but not limited to systems, applications, or software as a service (SaaS) or other platforms potentially but not limited to through an application programmer interface (API), message, notification, signal, calendar entry, email, token, or any combination thereof. Such interfacing entities may include but are not limited to, Microsoft Teams, SharePoint, MS Project, GoogleDocs, Google Calendar, Twilio, Zoom, Webex, Slack, Trello, LiquidPlanner, Asana, Adobe, IBM, WorkDay, or Zulip. In certain embodiments, the FFSS 302 may process all or some user data, all or some user entered or all or some displayed, processed or reviewed information in a trusted execution environment (TEE) whether the confidential computing technology employed is software or hardware enabled. The gathered data may be securely passed to the MS 304 to be forwarded anonymously to the sDAASS 306.

In certain embodiments, the FFSS 302 may configure a self-assessment service for the user which queries the user for information about, but not limited to, self-perceptions, self-performance reflections, preferences, personality characteristics, learning style, knowledge levels in various content areas, prior education and training, cognitive capabilities, social and emotional skills, knowledge about organizations, departments projects, events, including but not limited to goals, tasks, deliverable, contingencies, timeframes, leadership, management, other team members, other teams and their members deliverables, handoffs, and objectives, whether in a multiteam system or otherwise, or personal, team, multiteam system, or organization, or career, goals or aspirations.

In certain embodiments, the FFSS 302 may configure a professional or other self-development planning service for the user which queries the user for information about, but not limited to, the users learning objectives, goals, aspirations, and preferences, learning style, with respect to but not limited to knowledge levels in various content areas, prior and desired education and training, cognitive capabilities, lesson preferences, knowledge levels, social and emotional skills, knowledge about organizations, departments projects, events, including but not limited to goals, tasks, deliverable, contingencies, timeframes, leadership, management, other team members, other teams and their members deliverables, handoffs, and objectives, whether in a multiteam system or otherwise.

As indicated above, the system 100 may also include another subsystem, the sDAASS 306. The sDAASS 306 may be a data storage and analytics processing platform supported by machine learning, artificial intelligence, expert systems, panels of human experts, or some combination thereof. In certain embodiments, the sDAASS 306 may include software, hardware, or a combination of software and hardware. In certain embodiments, the sDAASS 306 may reside on the first and/or second user devices 102, 111, the third user device 115, the servers 140, 150, 160, the communications network 135, the computing device 120, the external network 165, any other devices, systems, and/or locations, or a combination thereof. In certain embodiments, the sDAASS 306 may include any number of servers, interfaces, sensors, devices, programs, modules, or a combination thereof, to facilitate the performance and functionality of the sDAASS 306. The processing performed by the sDAASS 306, which includes, but is not limited to, data mining, item or vote counting, individual or decision ranking, dynamical systems processing, statistical analysis, scientific studies such as, but not limited to, theory-based hypothesis testing, may be used to analyze user and system data related to, but not limited to, user interactions, organization state information, or environmental data. The processing conducted by the sDAASS 306, may also include, but is not limited, to conducting and executing various scenarios and simulations. Together, these analyses may serve as inputs for user reports, feedback and recommendations generated by the system 100. The data generated and/or analyzed by the sDAASS 306 may be securely passed to the MS 304 to be forwarded to the CFSS 308. In certain embodiments, the CFSS 308, which is described further below, may process all or some system-generated or user data, all or some user entered, or all or some displayed, processed or reviewed information in a trusted execution environment (TEE) whether the confidential computing technology employed is software and/or hardware enabled.

In addition to the FFSS 302 and the sDAASS 306, the system 100 may include a MS 304, which may be a secure firewall protected processing platform that encrypts and stores two-way mapping relationships between live user identities and avatar identities. The former allows user to provide and access data about others in a secure and anonymous technology context. The latter enables the user to receive privately and anonymously, secure feedback which no other human being can access without the user's permission (as determined by selections in the user's personal profile). In certain embodiments, the MS 304 may include software, hardware, or a combination of software and hardware. In certain embodiments, the MS 304 may reside on the first and/or second user devices 102, 111, the third user device 115, the servers 140, 150, 160, the communications network 135, the computing device 120, the external network 165, any other devices, systems, and/or locations, or a combination thereof. In certain embodiments, the MS 304 may include any number of servers, interfaces, sensors, devices, programs, modules, or a combination thereof, to facilitate the performance and functionality of the MS 304. In certain embodiments, the firewall 125 may be integrated into the MS 304 and/or communicatively linked to the MS 304.

As indicated above, data is passed securely from the sDAASS 306 to the MS 304, which then forwards the secured data to the CFSS 308, which may be another subsystem of the system 100. In certain embodiments, the CFSS 308 may be a technology-supported user-experience and interaction platform that enables users to receive feedback about their perceived competence, relative rankings, contribution, engagement, or performance during events and interactions as described anonymously by others with whom they interact. In certain embodiments, the CFSS 308 may produce output reports, analyses, and/or recommendations. The CFSS 308 may transmit and/or otherwise provide the reports, analyses, coaching tips, micro-lessons in various subjects, behavioral signals or triggers, encoded tactile, electromagnetic or acoustic wave, or olfactory sensory patterns which may or may not to stimulate learned cognitive activity, and/or recommendations to users, such as by transmitting the reports, analyses and/or recommendations to the first and/or second user devices 102, 111. The CFSS 308 may provide access to a customized interest-indexed streaming media database of content (e.g. database 155) that is available for augmenting analyses and as support for mentoring or coaching recommendations that are intended to improve future performance of users. In certain embodiments, the CFSS 308 may reside on the first and/or second user devices 102, 111, the third user device 115, the servers 140, 150, 160, the communications network 135, the computing device 120, the external network 165, any other devices, systems, and/or locations, or a combination thereof. In certain embodiments, the CFSS 308 may include any number of servers, interfaces, sensors, devices, programs, modules, or a combination thereof, to facilitate the performance and functionality of the CFSS 308. In certain embodiments, the CFSS 308 may process all or some system generated or user data, all or some user entered, or all or some displayed, processed or reviewed information in a trusted execution environment (TEE) whether the confidential computing technology employed is software or hardware enabled.

The various subsystems may interact and have relationships to each other. For example, the FFSS 302 and the MS 304 may regularly communicate and interact with each other in a secure and dynamic fashion to ensure that the data acquisition process (obtain feedback and/or other relevant data) is secure and that complete anonymity is provided for all users. Once data entered by a user has passed successfully from the FFSS 302 to the MS 304, the source data on the FFSS 302 may be erased from the FFSS 302. Once the received user data on MS 304 (i.e., received from the FFSS 302) has been encoded and assigned to corresponding avatar identifiers and potentially, but not limited to, organization and environment codes (numeric or other types of codes), to become anonymized data, the user data may be erased from the MS 304. In certain embodiments, this erasure could be required, but not necessarily, to occur before the anonymized data about any individual user's entry, assess and interactions with the FFSS 302 is passed securely to the sDAASS 306. In certain embodiments, information from the A&PSS 310 may be integrated into the information from the FFSS 302 before being passed securely to the sDAASS 306. Upon first use, the MS 304 may create a unique avatar for a given user. This avatar may be embedded anonymously in virtual organizations and virtual social networks consisting of all other users of the system 100.

The MS 304 may then pass all data that has now been assigned securely and anonymously to corresponding uniquely defined avatars by the MS 304 to the sDAASS 306 for further processing. The sDAASS 306 may pass condition state data for all avatars that have been securely assigned for each live user to the MS 304 for processing. Additionally, the MS 304 may continuously interact dynamically and securely with the CFSS 308 to ensure that the reporting, coaching and recommendation process is secure and preserves anonymity for all users. Once a given avatar's condition state report and recommendation package is received securely by the MS 304 from the sDAASS 306, the MS 304 may access its firewall protected, (potentially Blockchain and/or distributed ledger technology-secured), user-to-avatar mapping index files and assign the avatar's condition state report to its user and that user's interest-state-at-time-t. Once this assignment is verified, the avatar condition state record may be erased from MS 304. In certain embodiments, the erasing may be performed before the MS 304 securely passes the user's ‘interest-state-at-time-t’ to the CFSS 308. In certain embodiments information from the A&PSS 310 may be securely integrated into the CFSS 308 to access coaching media and resources that are specific and contextually relevant to a given user's needs and interests at a point in time.

Operatively, the system 100 may operate and/or execute the functionality as described in the methods of the present disclosure and in the following use case scenarios. In a first use case scenario, users may interact with their smartphones and other technologies to augment their social interactions in events such as meeting and presentations. This may occur in two contexts. First, during and after meetings and events, users are queried by the application about their experiences with respect to each other participant and with the group itself in the context of the event itself. Second, each user receives targeted mentoring and feedback that is customized for the user based upon specific feedback and near real-time data analytics based upon the combined historical experiences of all other system 100 users as well as state of the art research results in social science. To support these uses, the system 100 utilizes big data techniques, artificial intelligence, expert systems and computational modeling simulations, as well as human experts.

In certain embodiments, a use case may include utilizing a software application for, but not limited to, a smartphone, such as first user device 102. The software application may incorporate any of the functionality and features described for the system 100 and/or method described in the present disclosure. The application enables or queries the user to give feedback about others for the benefit of the others in their personal development and self-awareness. This input of feedback may be asked of each user (such as via the application executing on each user's device) before, during or after and event for at least one other person (who is also a user) and with whom the focal user interacts (even but not limited to, simply by listening) during an event, meeting, an experience, or campaign over a period of time. These data may then be compiled and processed using data analysis techniques as well as machine and human intelligence and expertise. The feedback may be provided to each individual user privately and anonymously and either through personal interaction with a coach, mentor, and/or supervisor through the users' smartphone or in-person to help the users improve their management, interaction, presentation or self-monitoring skills to enhance future performance. These data may be aggregated anonymously for use by a larger organization.

In certain embodiments, a self-assessment may be performed by constructing a survey instrument or other query which may but not necessarily be constructed or assembled using, but not necessarily data about the situational, learning, or aspirational context of the first user or of a second user or some combination thereof a survey or other query and perhaps but not necessarily request a response. The information used by the system 100 to construct this instrument may but not necessarily be associated with a conceptual model that considers one or more, attributes, behaviors or other observable metrics in the context of their hypothesized statistical relationships first order, second order third order, or other level latent variables or factor some or all of which may or may not be validated empirically. In certain embodiments, observed attributes, behaviors, other observable metrics, or latent variables used to but not limited to construct the instrument, report or to identify User Interest code, may be one of or be some combination of: accountability, active listening, administrative activities, adaptability, agility, approachability, authenticity, authority, autonomy, autonomous contribution, consistency, contribution, balanced decision-making, balanced processing, collaborative contribution, community building, competence in areas such as but not limited to industry, technical, functional, cultural, information and communications technology, information elaboration, a metric of innovation, creativity, or physicality, citizenship behaviors, committed, confident, clarity (clear communication), clear thinking, comradery, consideration, convergent, curiosity, divergent, followership, emotional intelligence, empathy, enabling, engagement, evidence, generative activities, humor, initiative, innovative, intellectual stimulation, leadership, mental toughness, clear values or moral compass, climate, openminded, organizing, a metric of performance, predictable, preparedness, proactive, psychological safety, self-awareness, relational transparency, relevance, respectfulness, self-awareness, self-regulation, supportiveness, team norm strength, transformational contribution transparency, trust, generalized, trust, individualized trust, or workplace climate.

As indicated above, the functionality provided by the system 100 may be incorporated into a software application. The application may interact over a telecommunication network with controller software of the system 100 and a database 155. In a use case scenario, the application may optionally notify the user that either it is time for the user to give feedback and/or, but not necessarily, it is time for a user to get feedback. If it is time to give feedback, the user may be queried through subsystem(s) of the application to give specific feedback about their impressions of one other individual with whom the user had a meaningful interaction during an event or meeting. This may occur as the user interacts with the application locally, such as on the first user device 102 of the first user 101. When the user hits “submit” these data may be transferred from the first user device 102 to a server (e.g. server 140) on the network which contains the controller software for storage in these databases 155. In certain embodiments, an optional notification feature where the system 100 sends the user the notification to give feedback when a device calendar application indicates that a scheduled event has begun or is about to be completed may be utilized as well.

In certain embodiments, the survey instrument or other query used to gain feedback about and for one user from a second user may but not necessarily be constructed or assembled perhaps using but not necessarily data about the situational, learning, or aspirational context of the first user or of a second user or some combination thereof a survey or other query and perhaps but not necessarily request a response. The information used by the system 100 to construct this instrument may but not necessarily be associated with a conceptual model that considers one or more attributes, behaviors or other observable metrics in the context of their hypothesized statistical relationships or first order, second order, third order, or other latent variables or factors some or all of which may but not necessarily be validated empirically. In one embodiment, observed attributes, behaviors, other observable metrics, or latent variables used to but not limited to construct the instrument, report or to identify User Interest code, may be one of or be some combination of: accountability, active listening, administrative activities, adaptive, agile, alignment, approachability, authenticity, authority, autonomous, autonomous contribution, authority, consistency, contribution, balanced decision-making, balanced processing, collaborative contribution, connected, community building, competence in areas such as but not limited to industry, technical, functional, cultural, information and communications technology, information elaboration, creative, or physical, citizenship behaviors, committed, confident, clarity (clear communication), clear thinking, comradery, consideration, contribution, convergent, creativity, curiosity, divergent, followership, emotional intelligence, empathy, enabling, engagement, evidence, generative activities, humor, initiative, innovative, intellectual stimulation, leadership, mental toughness, clear values or moral compass, climate, openminded, organizing, performance, predictable, preparedness, proactive, psychological safety, relational social sensitivity, transparency, relevance, reinforcement learning, respectfulness, self-awareness, self-regulation, supportiveness, team norm strength, transformational contribution transparency, trust, generalized, trust, individualized trust, valence, versatility, valence or workplace climate.

In certain embodiments, if it is time for the user to receive feedback, the software on the user device presents the user with feedback in the form of aggregated raw data about how the user performed at a recent event. The user could then use this information to alter their behavior in future events. In the optional case of notifications, the software on the user device may send its user the notification to receive feedback when the user device software receives a message from the controller software that includes that recommendation package within the message. It is this recommendation package that may be presented to the user by the software in the user's personal device. The controller software (functionality may be provided by the subsystems) may receive and store data from users. The controller software may also run programs for each completed event by aggregating data across its users to analyze the results and prepare recommendation packages for a user. When a recommendation package is ready for the user, the recommendation package may be sent to that user's smartphone or other device. In certain embodiments, the software on the user's device then sends a notification to the user to receive feedback.

In another embodiment, the system 100 is also meant to incorporate other more complex features, functions and attributes. In this more complicated embodiment, the application on the smartphone (or other appropriate device) notifies the user that either it is time for them to give feedback about a recent event or it is time for them to get feedback about a recent event that is relevant for at least one future event. If it is time to give feedback, the application identifies this from its database 155 or its interaction with other applications of the system 100. This triggers a query to the user through the smartphone application asking the user to give specific feedback about their impressions of each other individual with whom the user had a meaningful interaction during the identified event or meeting. The application also accesses specific information about the event both to determine the questions included in the queries of the user and when compiling the reports and recommendations. If the notification signals the user that it is time to receive feedback, the user may be presented with options including the events for which feedback is available as well as the types of individual feedback they can review, including, but not limited to, anonymous raw data, aggregated data as compared with others, data presented in an historical context, analysis of these data, automated coaching based on these data, human expert advice based on these data, streaming content identified by the system as appropriate, or live interactions with a human mentor or expert.

In another embodiment, the controller software could manage encryption/decryption and cybersecurity processes in conjunction with the application and databases 155 to ensure anonymity and security for each user. The processors of the system 100 may perform operations and execute instructions to actualize this embodiment of the system 100. In a further embodiment, the secure database 155 contains secure and anonymous copies of all data gathered through the application, as well as organizational and environmental context data gathered from other sources and maintains a complete history of all data and all recommendations for the purposes of future analysis. In another embodiment, these data would be compiled and processed using proprietary data analysis techniques and copyrighted feedback would be provided to each individual user to help the users improve their performance, such as at during future events, projects, and/or meetings. Data collection at the individual level about other individuals by, for example, but not limited to a smartphone, aggregation and analysis of all data about an individual's performance or interactions or team or multiteam performance using a computer processor and transmitted back to the user as aggregated feedback about how that user was perceived by others during the event. In another embodiment, the data gathered could be collected in real time using wearable technologies (e.g. device 115) or from surveillance (e.g. device 120) or other devices such as related to the Internet of Things or personal assistant devices (e.g. Amazon Alexa and the like) and likewise, recommendations could be delivered in real-time through wearable, personal assistant (e.g. Amazon Alexa) and/or other technologies and/or even through a third party.

In a use-case scenario, the system 100 may be utilized for creating and/or supporting a user's virtually-augmented social network. Initially, the first user 101, for example, may download an application providing the functionality of the system 100 and methods onto the first user device 102. The application, for example, may be downloaded from one or more components of the system 100. The first user 101 may be prompted to register with the application, such as via the application itself, if the first user 101 is not already a registered user of the system 100. During the registration process, the system 100 communicates over a secure, encrypted network with a secure MS 304. On the MS 304, a user identifier (User_ID) is assigned and mapped to a unique, newly created virtual identifier (Virtual_ID) called the Avatar_Node_ID. The Avatar_Node_ID is a node in one or more virtual social network(s) used to augment real world human social networks of the system's 100 users. This mapping may, but does not necessarily, use blockchain and/or distributed ledger technologies and/or similar coding, algorithms, or processing. The mapping of the User_ID to the Avatar_Node_ID is the secure and anonymous way that the user, through its unique User_ID, interacts with other system 100 users (e.g. second user 110) through their Secure Avatar_Node_ID.

In this use-case scenario, the first user 101 may be allowed to join networks, projects or institutions of other users, such as second user 110. Once registered as a user in the system and while in the application, the first user 101 may have already been, or could in the future be asked by other users (e.g. second user 110) to participate in those other users' trusted networks. In certain embodiments, this may occur when the first user 101 is included in another user's (e.g. second user 110) event. From the system's 100 perspective, the assignment of participants to events may be anonymous. The assignment may occur on the secure side of the MS 304 and behind a firewall 125 on the main virtual network system processing servers. On the main system servers (e.g. server 140, server 150, and/or server 160), it is actually the focal user's (e.g. first user 101 in this case) Avatar_Node_ID that is added to a virtual event (Virtual_Event) by another User's Avatar_Node_ID. This virtual event also includes the Avatar_Node_IDs of other participants in the event. Once an event is established behind the firewall 125 in the main system 100, the event may be passed back through the MS 304 where the Virtual_Event is used to create a real live event (Real_Event) with real users for the purposes of data collection. This Real_Event record includes, but is not limited to, its event identifier (Event_ID), event type (Event_Type, start date (Start_Date), project (Project_Type), project type (Project_Type), institution (Institution), institution type (Institution_Type), start time (Start_Time), end date (End_Date), end time (End_Time), event location, actual User_IDs (as identified in a secure mapping from the Avatar_Node_ID.) for users who enters the data, actual User_IDs (as identified in a secure mapping from the Avatar_Node_ID.) for users about whom the data applies, each individual's role or participation type, the study requirements for each user (Study_ID), and the queries or survey (Survey_ID) to be sent to each user as well response given by each user (By_User_Response). This Real_Event is created by mapping each Avatar_Node_ID to its User_ID, including that of the focal Users' User_ID. This mapping may, but does not necessarily, use blockchain or similar coding, algorithms, or processing to secure the mapping. In certain embodiments, users can accept the event or not depending upon their preferences. In certain embodiments, in commercial-license situations they may be expected, at least through normative pressures, to accept the invitations from their work teams.

Feedback can be provided through the system 100 during real events through various techniques including, but not limited to, surveys, queries, screen swipes, audio, video, written, or other media, surveillance technologies, wearable technologies, biometric, thermal tracking or geo-positioning technologies. In a preferred embodiment, the first user 101 may be presented with a survey on the first user device 102, such as a smartphone, tablet or other computer interface. For example, when the first user 101 is asked to provide feedback to other users (e.g. second user 110) by responding to a query such as a survey about their contribution and engagement at a recent event, this request would go through the following steps: (1) An event is identified as scheduled to occur within the virtual social network made up of Avatar_Node_IDs. This could have happened, but not necessarily, because a real-world user set up a real-world event. As described herein, this may be implemented securely through that User's User_ID as mapped to an Avatar_Node_ID in the virtual social network for implementation in the system 100 as described herein. (2) The Avatar_Node_IDs that are scheduled to attend the event in their virtual social network together with their different roles (which are needed to determine which studies will be implemented) are the context in which a particular Avatar_Node_ID participates in a virtual event as the avatar of the focal user (first user 101) who participates in a real-life event. The virtual event effectively mirrors in the system 100 the real-life event that is occurring in physical space. (3) For each of these virtual participants, the MS 304 does a reverse mapping to create an event for each user that includes the User_IDs of those participants and their roles in the event. (4) The system 100 then creates a unique event_protocol for each user that is to be implemented when the real-world user or the calendar or an algorithm suggests that the interval for feedback has begun. The reporting period for a given event remains open until the calendar indicates that the reporting interval is over. (5) For each user, the event_protocol includes: i) the User_ID who will be queried; ii) Other participants by name (though their User_IDs to be given feedback through the query); iii) The questions to be answered for that participant for this event. (6) Once the reporting interval is over, the system 100 produces a series of reports that are made available for each user. In certain embodiments, these reports are only produced if there is enough data to retain anonymity or according to some other criterion. (7) The information from these reports is processed and an anonymous summary event_report is temporarily associated with the User_ID and transferred to the Mapping Server along with the User_ID. (i). The event_report includes the event data, the feedback received from each study and a vector that describes the directed weights of each User_ID with which the focal User_ID interacted during the event. (8) On the MS 304, the event_report is securely translated from local User_IDs into Avatar_IDs on the virtual social network. The event_report on the system 100 may then be deleted from the system 100 for security reasons such that the report can be securely accessed only by the focal user through the secure MS 304 mapping.

User Experience (UX) Perspective: Based upon this processing, the focal user (i.e. first user 101) is presented with an isolated real-world event and asked to join the event and provide anonymous feedback to the other participants. From the perspective of a user, interacting with an event is transactional although it also occurs in the context of real-world relationships with the other real-world participants. Augmented Social Network Perspective: Each Virtual_Event is stored along the secure and anonymous data captured at that event in the context of the virtual social network maintained in the system 100. It is associated with relevant virtual entities and activities, including, but not limited to: 1. The various Avatar_Node_IDs that were involved. 2. The studies and their study parameters to which the data applies including but not limited to personality traits or other attributes of the individual users associated with the Avatar_Node_IDs. 3. Any relevant formal and informal teams, multiteam systems, associations, affiliations, identity groups or special interest groups, or other social structures that may be identified by the user, other users or the system through its machine learning, artificial intelligence or interfaces with human experts or Researchers. 4. Organization_State_Variables such as, but not limited to: internal projects, multiteam systems, initiatives, departments, budget item, activity type, position in organization structure, topic area, function, category of event, or other items that might be associated with the event. (a) Examples of these might be, but are not limited to, the level of Employee Engagement factor in the organization, location, department or workgroup which may be entered by the administrator based upon an offline HR study, or calculated by the system based upon prior Studies made by the system 100. (b) Another example might be the level of financial or other performance measure of the organization, location, department or workgroup which may be entered by the administrator based upon an offline HR study, or calculated by the system based upon prior studies made by the system 100. (5) Environmental_State_Variables such as, but not limited to: market segment, location, technology, economic situation, political situation, government program supplier contract, customer contract, sales activity or contract, logistics or distribution activities or contracts, external projects, initiatives, departments, or other items that might be associated with the event. (a) Examples of these might be, but are not limited to, the customer, partner or supplier involved and the level of a Customer Satisfaction factor in the organization, location, department or workgroup which may be entered by the administrator based upon an offline marketing study or gathered or calculated by the system based upon prior studies made by the system 100. (b) Another example might be the size of a customer or other contract, or specific governmental agency or type of agency involved as identified and entered by the administrator or gathered or calculated by the system based upon prior Studies made by the system. (6) Leadership_Activities_Variables such as, but not limited to: town hall meeting, status meeting, project meetings, strategic discussions or initiatives, consulting contracts or other items that might be associated with the event. (a) Examples of these might be, but are not limited to, the level of collective, shared, hierarchical, emergent, generative, administrative or community building leadership activities that are observed over time in the organization, location, department or workgroup and the assignment of individuals to roles which may be entered by the administrator based upon an offline Leadership study or calculated by the system 100 based upon prior studies made by the system 100. (b) Another example might be the level of various factors associated with transformational, transactional, charismatic, authentic or other leadership style in the organization, location, department or workgroup which may be entered by the administrator based upon an offline human resource leadership study or calculated by the system based upon prior studies made by the system 100.

Users Can Establish A Virtual-Event in the Virtual Network: In the application, a user can decide to establish a virtual event in conjunction with a real-life event. In addition to providing and receiving feedback for professional improvement through the application, establishing the virtual event also helps the system to virtually augment interactions in the user's real-life Social Network in future interactions. For example, prior to a meeting, the user can be reminded of social interaction dynamics that have occurred during prior meetings of this type with some or all of the same actors and provide some coaching to enable greater effectiveness. A user can add a virtual event (that is correlated with a real-life event) by, but not limited to, doing the following with the user interface of the application: 1. Select a “create an event” function; 2. Select the event type; 3. Enter some of the date, start time, end time, or other data. 4. The study or studies to be carried out before, during or after the event can be specified, otherwise the system could, but would not necessarily assign a default study. 5. Select a team or otherwise identify participants. 6. Optionally, select a project to which event pertains. 7. Optionally, the user might assign roles to various participants. Once the event is created on the user interface side of the secure mapping service (MS 304) and firewall 125, the user's event_record is securely passed to the MS 304. On the MS 304, user IDs are mapped and replaced by their corresponding Avatar_Node_IDs. Likewise, all event data are passed through the MS 304 to create a Virtual_Event that corresponds to the real-life event but is not directly linked to the real-life event. It is only linked by the User_ID that initiated it through the backward link from that user's Avatar_Node_ID.

The User's Virtually-Augmented Social Network (V-ASN): By using this system 100 regularly, users in interactions with their real-world social networks have the opportunity to be securely and confidentially supported by their own dynamic personal augmented reality version of their network for purposes of getting and receiving feedback, making sense of candid reactions, and gaining emotional support through the system on a going-forward basis. The system 100 may be characterized by individual users creating and maintaining their own personal virtual networks by starting projects or activities connecting to others involved in events, presentations, etc., providing feedback back and forth etc., and evaluating other people's performance for the purposes of maintaining and storing that information for future use. However, the system 100 may store this network information in a large-scale virtual network that is completely anonymous which could eventually include millions of users. Notably, administrators who had access to sections of, or even the entire, virtual social network may not know which Avatar_Node_ID in that network was the node associated with any given user. Furthermore, they could not change or interfere in the virtual network in any way. However, copies and changes could be made for simulation, research and training purposes.

In certain embodiments, a Condition_State is an attribute of every Avatar_Node_ID: Each Avatar_Node_ID in the virtual network may have a condition_state. The condition_state is a tensor-matrix that is a timeseries snapshot of that avatar-node's relationships with everyone in its network as these change over time. In certain embodiments, through a secure mapping, this state is precisely the system's 100 view of an individual user's state, but that user's identity would be unknowable to the administrators. The view from an Avatar_Node_ID into the virtual network would only be visible to the particular user that is securely mapped to the Avatar_ID. Thus, from the subjective perspective of a given user, “I could trust” that “my network” would be visible to “me” as a user, but only to me. This individualized view would include information about other people in my social network, my evaluation of those other people as well as anonymized feedback from other member users about past interactions at various events. When accessed by the user, this view would be constructed in real-time through secure mapping into the virtual network through the Avatar_Node_ID and back to the user. These data that related to other real-life user would be immediately erased from the user's device after the user accessed it. If needed again, it may be reconstructed. In certain embodiments, the Condition_State may include a complete history of all events and a representation of all network connections between each focal Avatar_Node_ID with other Avatar_Node_IDs. The Condition_State may incorporate the following: (1) Avatar_Node_ID; (2) Table of connected Avatar_Node_IDs and interaction events; (3) Table of events and Event_Reports.

In certain embodiments, a Condition_State_Type is a class of Condition_States: During batch processing, on the virtual network servers (may be implemented on any of the servers 140, 150, 160), for each Avatar_Node_ID, its Condition_State(s) which include the complete history of all interactions with other Avatar_Node_IDs, Event_Reports and potentially contextual data such as Environmental_State_Variables, Organizational_State_Variables, or Leadership_Activities may be processed and projected onto a finite number of Condition_State_Types that may be defined by administrators for purposes of classifying user needs and interests and for identifying media to be presented to the user who is associated with the Avatar_Node_ID. Each user may have one or more Interest_States: Each Condition_State_Type for an Avatar_Node_ID may be mapped to its corresponding User_ID as an Interest_State assigned to the live user. The Interest_State may also include the following context specific data: (1) Environmental_State_Variables might include but are not limited to: government or regulatory issues; economic or political conditions; supplier and logistical considerations; customer or buyer needs; industry macro conditions and competitive rivalries; threats of new entrants and the threat of substitutes; and so forth. (2) Organizational_State_Variables might include but are not limited to: formal organizational structures; workgroup, department, or organizational objectives; organization policies, budgets, financial conditions; and so forth. (3) Leadership_Activity_Variables might include but are not be limited to: levels of administrative activities, individuals assigned to roles, generative or adaptive activities, vision or enabling activities.

In another use-case scenario, the system 100 may be utilized in the context of virtual and/or augmented social networks, BlockChain, and/or distributed ledger technologies. In particular, the system 100 may generate and establish and/or communicatively link with an augment social network for each user and/or a group of users. Once established, a user's augmented social network can be activated through contingent agreements and contracts utilizing blockchain technology and an associated proprietary cryptocurrency. In certain embodiments, each user of the system 100 may have a store of cryptocurrency points. For example, in certain embodiments, users may accumulate cryptocurrency points (e.g. numerical points) from the system 100 for providing feedback and coaching to other users of the system 100. In certain embodiments, users can also accumulate cryptocurrency through transactions with other users, by for example, but not limited to, payment for project work. In certain embodiments, these cryptocurrency transactions can, but not necessarily, be tracked via blockchain or other similar technologies.

In certain embodiments, each user may be configured to only view and/or access their own individual network within the virtual social network and have no visibility into other networks associated with other users. This may be accomplished by assigning each user a virtual identifier (e.g. numerical, alphabetical, symbolic and/or any other type of identifier) and a virtual avatar, together called a Virtual_Node_ID. All information may be transferred to these secure and anonymous Avatar_Node_IDs. In certain embodiments, portions of the virtual network may be visible to administrators and other levels but only in a completely anonymous form. In other words, the first user 101 could look at the virtual_network and identify the highly connected or centralized virtual_nodes to understand the organization's internal social network structure including the directed strength of various connections along various dimensions such as subject matter expertise, contribution, engagement, trust, and so forth. The user, however, could not see through the structure to identify which actual users were associated with which Avatar_Node_IDs or which virtual interactions were between which actual users. In certain embodiments, the users might be able to infer some of the reflection of reality into the virtual_network, however, the system 100 would not and could not confirm this information.

In addition, in certain embodiments, no information that the user input in or received from the system 100 at the individual level would ever be directly available to these administrative users. In certain embodiments, only aggregate data would be made available for inspection and access. To summarize: if one is a level_one user, the user creates projects; the user interacts with his trusted network; The user contracts for services from and/or transfer cryptocurrency points to others; The user provides feedback to all of the user's network members, and the user also receives feedback from individuals in his network about what the user is doing and how well the user is doing it. The user is capable of communicating with other real-life users anonymously, and the feedback the user receives may be based upon real life experiences so that the user can process and understand it in context. The user may not know exactly who is providing what feedback. Also, as an option and in certain embodiments, the user can select individual users in the user's individual network and choose to have the system 100 discard the feedback of that user so that feedback from some whom the user might not respect or trust, would not be part of the user's “trusted feedback” signal. This may be based on one or more User_Interest_State(s) assigned to the user based upon the Condition_State_Type(s) assigned to my Avatar_Node in the network.

In another use-case scenario, the system 100 may be utilized in the context of creating studies. In certain embodiments, Level 1 users of the system 100 typically only use the system 100 to respond to events and provide feedback that will help other users and to receive feedback about their own engagement and contribution to various events in which they participate. These user interactions with real life events, as they are reflected and augmented in the system, occur in the context of what the system calls a “study”. In the system 100, studies may be selected by level 2 users and may be designed and operationalized by level 2 and higher users depending upon the scope of the study. Each study may include a data collection protocol which involves: 1. The specification of events including but not limited to self-assessments to be sampled; 2. Information to be gathered about the events; 3. Methods to gather this data from various techniques, including, but not limited to, surveys, sensing devices, surveillance devices, media analysis, wearable technologies, geo-positioning devices, and so forth; 4. Data aggregation, categorization and segmentation protocols; 5. Analysis protocols; 6. Intervention possibilities for different categories of results; 7. Reporting protocols such as presentation and timing, and 8. Gathering feedback about the usefulness of reporting to users. As an example, when a Level 1 user accepts participation in an event, that user becomes part of a study identified by the Level 2 user for that event.

In certain embodiments, studies may be utilized as the default for new users. In the default case for Level 1 users, the level_Default_Study may be operationalized. This may be done as follows: 1. Each user receives a query asking for feedback about others who participated in various ways at an event. The user's name is not included in the query as no feedback is given to the self. 2. The user selects Participant_1 (listed by actual name given in the account). 3. If Participant_1 has a role defined as “Participant”, the user is asked to rate that user on some survey items (i.e., questions), for example, but not limited to “level of engagement” and “level of contribution”. 4. If Participant_1 has a role defined as “Presenter”, the user is asked to rate that user on further items, for example, but not limited to: “level of preparation” and “level of relevance”. This is in addition to the queries associated with being a participant. 5. If participant_1 has the role subject matter expert (SME), the user is asked to rate the SME on further items, for example, but not limited to “level of clarity when answering questions” and “willing to engage at the questioner's level of understanding”. This is in addition to the queries associated with being a participant. 6. Other roles can be defined, and other questions can be defined for each role by a Level 2 or greater users with appropriate permissions. 7. The input may be a scale of 1 to 100, although the actual format for data collection can be customized. For example, the respondent might be asked to choose one of five smiley faces that range from deep frown (0) through neutral (50) to extreme smile (100). As another example, the respondent might be asked to indicate whether the participants level of preparedness, or some other attribute such as relevance, authenticity, clarity, respectfulness of evidence, “worked for me”, was “less than expected”, or “even more would be better”, with responses being scored by the system on a scale from −1 through 0 to +1, with 0 being ideal. However, in some or all cases, the data are assumed to be identified as points along a continuous scale from 1 to 100. 8. Users may be asked to respond to questions about the state of the entire team or multiteam system and/or its collective performance at an event. This might be done by using an instrument with a scale that measures one or more aspects of team, multiteam system, or organizational performance. 9. Once the data are collected from all participants about all other participants of the event or the event is closed, whichever is first, the system identifies the users for whom there are enough data from the responses from other users to maintain everyone's anonymity, and reports are prepared for those who can receive anonymous feedback. 10. A notification that feedback is ready for them is sent to each user. 11. Those users who receive feedback may be presented with a selection of various reports as defined by the study. For example, they could choose to review a simple report of their average scores for their role at the last event, a report that compares results from the last several events, or a report about the score of the whole team.

With regards to the default case for level 2 users, the level2_Default_Study may be operationalized. This may be done as follows: 1. Each user receives a query asking for feedback about others who participated in various ways at an event. The user's name is not included in the query as no feedback is given to the self. 2. The user selects Participant_1 (listed by actual name given in the account). 3. If Participant_1 has a role defined as “Participant”, the user is asked to rate that user on some items, for example, but not limited to, “level of engagement”, “level of contribution”, “level of subject matter expertise”, “level of opinion valued by others”, and “level of experience in role”. 4. If Participant_1 has a role defined as “Presenter”, the user is asked to rate that user on some items, for example, but not limited to, “level preparation” and “level of relevance”. 5. Other roles can be defined, and other questions can be defined for each role by a Level 2 or greater user with appropriate permissions. 6. The input may be a scale of 1 to 100, although the actual format for data collection can be customized. For example, the respondent might be asked to choose one of five smiley faces that range from deep frown (0) through neutral (50) to extreme smile (100). As another example, the respondent might be asked to indicate whether the participants level of preparedness, or some other attribute such as relevance, authenticity, clarity, respectfulness of evidence, “worked for me”, was “less than expected”, or “even more would be better”, with responses being scored by the system on a scale from −1 through 0 to +1, with 0 being ideal. However, in some or all cases, the data are assumed to be identified as points along a continuous scale from 1 to 100. 7. Users may also be asked to respond to questions about the entire team's or multiteam system's performance at the event using a similar scale including but not limited to identifying those members who contributed the most to an event or project. 8. Once all of the data is collected from all participants about all other participants of the event or the event is closed, whichever is first, the system 100 identifies the users for whom there are enough data from the responses from other users to maintain everyone's anonymity, and reports are prepared for those who can receive anonymous feedback. 9. In addition, team and multiteam level reports are produced for review by the Level 2 users and above. 10. A notification that feedback is ready for them is sent to each user, such as to the first and/or second user devices 102, 111. 11. Those users who receive feedback are presented with a selection of various reports as defined by the study. For example, they could choose to review a simple report of their average scores for their role at the last event, a report that compares results from the last several events, or a report about the score of the whole team or multiteam system.

In certain embodiments, in the default case for Level 6-BOD Users, the Level6_Default_Study may be operationalized. This may be done as follows: 1. Each user receives a query asking for feedback about others who participated in various ways at an event. The user's name is not included in the query as no feedback is given to the self. 2. The user may select Participant_1 (listed by actual name given in the account). 3. If Participant_1 has a role defined as “Participant”, the user is asked to rate that user on some items, for example, but not limited to, “level of engagement”, “level of contribution”, “level of subject matter expertise”, “level opinion valued by others”, and “level of experience in role”. 4. If Participant_1 has a role defined as “Presenter”, the user is asked to rate that user on some items, for example, but not limited to, “level preparation” and “level of relevance”. 5. Other roles can be defined, and other questions can be defined for each role by a Level 2 or greater user with appropriate permissions. 6. The input may be a scale of 1 to 100, although the actual format for data collection can be customized. For example, the respondent might be asked to choose one of five smiley faces that range from deep frown (0) through neutral (50) to extreme smile (100). As another example, the respondent might be asked to indicate whether the participants level of preparedness, or some other attribute such as relevance, authenticity, clarity, respectfulness of evidence, “worked for me”, was “less than expected”, or “even more would be better”, with responses being scored by the system on a scale from −1 through 0 to +1, with 0 being ideal. However, in some or all cases, the data are assumed to be identified as points along a continuous scale from 1 to 100. 7. Users can be, but are not necessarily, asked to respond to questions about the entire BOD team's performance at the event using a similar scale. 8. Once all of the data is collected from all participants about all other participants of the event or the event is closed, whichever is first, the system 100 identifies the users for whom there are enough data from the responses from other users to maintain everyone's anonymity, and reports are prepared for those who can receive anonymous feedback. 9. In addition, BOD level reports are produced for review by the Level 6-BOD Users. 10. A notification that feedback is ready for them is sent to each user. 11. Those users who receive feedback are presented with a selection of various reports as defined by the study. For example, the users could choose to review a simple report of their average scores for their role at the last event, a report that compares results from the last several events, or a report about the score of the whole team or components of a multiteam system.

In certain embodiments, there may be various study types that may be utilized in the system 100. Notably, studies may involve the gathering, sorting, processing and reporting of information about individuals, groups of individuals, interactions, organizations, and institutions. Studies are designed and operationalized by users of Level 2 or higher according to their permissions. Additionally, surveys may be utilized with the system 100 as well. A survey may be an instrument used to gather data from targeted individuals at a point in time. In certain embodiments, there may be studies of several types utilized in the system 100. Studies may include, but are not limited to: 1. Pilot Studies gather data across a test or prototypical environment for a group, organization or institution at a point in time for the purpose of developing a validated measurement instrument that can be used in other studies. (a) An example of this would be a pilot of a twenty-item survey with a validated scale for measuring a hypothesized factor such as “innovation quotient”. The pilot study would gather data for the purpose of performing validation analysis and testing to determine if the survey provides a valid and consistent measurement of the hypothesized factor. 2. Transactional Studies gather data associated with a particular transaction such as an event that involves a group, organization or institution at a point in time. (a) An example of this would be a two-item survey with a validated scale for measuring “customer satisfaction” associated with a customer event. The survey would be administered to everyone at the event at a point in time with the intent of understanding the customer satisfaction dimension of an Environment_State_Variable for a particular event. 3. Cross-sectional Studies gather data across a cross-section of a group, organization or institution, or community, at a point in time including but not limited to a ranking of individuals. (a) An example of this would be a five-item survey with a validated scale for measuring “employee engagement” that would be administered to everyone in a particular hospital at a point in time with the intent of understanding this dimension of an Organization_State_Variable. 4. Longitudinal Studies gather data in a group, organization or institution over a period of time in an effort to understand a trend or changing state of the subject. (a) An example of this would be a five-item survey with a validated scale for measuring “employee engagement” that would be administered to everyone in a particular out-patient clinic of a hospital at several points in time to understand the change in this dimension of an Organization_State_Variable. 5. Comparative Studies gather data at two or more instances of a certain type of workgroup, organization or institution at a point in time. (a) An example of this would be a five-item survey with a validated scale for measuring “employee engagement” that would be administered to everyone in five different hospitals at a point in time to compare these targets along this dimension of an Organization_State_Variable. 6. Predictive Studies gather data about multiple factors that are collected at multiple instances from a certain target type of individual, workgroup, organization or institution at a point in time or over time. These studies are called predictive because the value of one or more of these factors is believed to predict the value of other factors which can be measured. The study analyzes these data with the intent of predicting other measurable outcomes. (a) An example of this would be a five-item survey with a validated scale for measuring “employee engagement” that would be administered to everyone in five different hospitals at a point in time to compare these targets along this dimension of an Organization_State_Variable. 7. Simulation Studies gather data about multiple factors that are collected at multiple instances from a certain target type of individual, workgroup, organization or institution at a point in time or over time. These studies use this data combined with theoretical and empirical results from predictive studies to simulate the values of other variables (for example, but not limited to, Organization_State_Variables, Environmental_State_Variables and Leadership_Activities_Variables) at some point or points in the future. These studies analyze the numerical data with the intent to determine potential interventions to improve outcomes as measured by these variables. (a) An example of this would be a five-item survey with a validated scale for measuring “customer_excitement” that is administered to participants at a customer meeting (an Environmental_State_Variable). The results would be used in a numerical model run on a computer to simulate the probability distribution of potential sales of various product in the next quarter (an Organization_State_Variable) so that production could be adjusted in anticipation of the most probable outcomes.

In certain embodiments, a user of Level 2 or higher may be allowed to select and/or create studies for the system 100. For example, a user with appropriate permissions can establish a study by taking the following steps: 1. Establish a new study and create Study_ID. 2. Select or create a survey. 3. Select an event or event type. 4. Schedule the data collections. 5. Add participants to the meeting(s) or event(s) and assign roles. 6. Select and schedule analysis and reporting. Data from all studies may be stored as individual response records and indexed by some of, but not limited to, User_ID, Data and Time of event, Date and Time of response, Event, Event-Type, Project, Project_Type, Institution, Institution_Type, Team, Team_Type and Organization Code to enable them to be accessed and analyzed in future studies as well.

In another use-case scenario, the system 100 may be utilized in the context of generating and maintaining a smart, personalized, and curated newsfeed. In addition to transaction or event-based feedback, in certain embodiments, the system 100 may also, but is not limited to, having an option to provide a newsfeed of personalized stored media about coaching and mentoring as well as connection to live coaching sessions or peer-to-peer exchange coaching sessions whether live, whether recorded or computer generated, or whether by video, audio, hologram or animated. In certain embodiments, this may include information provided by the organization as relevant to individual contributors. This allows the organization to utilize the system to translate int coaching tips and insights academic and practical articles. Some or all of these may be selected based upon the user's unique history and User_Interest_State(s) as determined machine and human learning and intelligence. In certain embodiments, curated media is sent to the user through the application at intervals during the day; however, particularly relevant media that is identified can override the normal schedule. In certain embodiments, the specific media presented to the user is selected uniquely for each user based upon its topic_matrix as determined by the system 100, machine learning, and artificial intelligence algorithms or human expert curators. This may occur as follows: 1. When media is created or identified from other sources, its copyright and distribution rights may be determined by the system 100. Media created on the system 100 by other system 100 users may, but not necessarily, be allocated crypto-cyber-currency (ccc) points as described herein according to a onetime grant or according to usage. 2. Items are screened for those available for distribution by the system 100 and any ccc rights or contingent payments are written to the blockchain described in the uses cases described herein. 3. Using machine learning, artificial intelligence algorithms or human experts, media content is tagged with a topic_matrix which includes vectors for various topic areas such as, but not limited to, influence skills, oral communication skills, team leadership, motivation, project management and so forth, that include relevant context dimensions such as industry, management level, geographic perspectives and so forth. 4. For each user, media is selected and scored based on the match of the User_Interest_State(s) with the topic_matrix for each item of content. 5. Based upon the relative scores of various media content, a newsfeed is constructed for each user and sent to that user's newsfeed queue. 6. Notifications are sent to the user from the newsfeed queue, and the user is presented with a newsfeed option when using the application. In certain embodiments, note that the User_Interest_State is assigned to each user by the system 100 based upon the Condition_State_Type(s) that is assigned to the user's secure Avatar_Node_ID in the virtually-augmented social network (V-ASN).

In certain embodiments, Condition_State_Type may be a Class of Condition_States. During batch processing, on the Virtual Network Servers, for each Avatar_Node_ID, its Condition_State(s) may be processed potentially, but not necessarily, using machine learning and artificial intelligence techniques such as, but not limited to, cluster analysis to project related and/or closely related Condition_State groups onto a finite number of Condition_State_Types (CSTs). In certain embodiments, note that Condition_States include, but are not limited to, the complete history of all interactions with other Avatar_Node_IDs, Event_Reports and perhaps contextual data such as, but not limited to, Environmental_State_Variables, Organizational_State_Variables, or Leadership_Activities as well as, but not limited to, other personality, cognitive, biometric, or physical metrics associated with the Avatar_Node_ID. These CSTs may be defined by administrators based on, for example, but not limited to, algorithms, machine learning, artificial intelligence, or human experts for purposes of classifying Condition States into a finite space of areas of user interest for purposes of social learning. In certain embodiments, Condition_State_Types are used to identify relevant media to be presented to the unique User who is associated with the Avatar_Node_ID. In certain embodiments, each user has one or more Interest_States. Each Condition_State_Type for a given Avatar_Node_ID may be mapped to its corresponding User_ID as its User_Interest_State at that point in time. An Interest_State could also, but not necessarily, include, but not limited to, the following context specific data: 1. Environmental_State_Variables might include, but are not limited to: government or regulatory issues, economic or political conditions, supplier and logistical considerations, customer or buyer needs, industry macro conditions and competitive rivalries, threats of new entrants and the threat of substitutes, and so forth. 2. Organizational_State_Variables might include but are not limited to: formal organizational structures; multiteam systems, workgroup, department, or organizational objectives; organization policies, budgets, financial conditions; and so forth. 3. Leadership_Activity_Variables might include but are not be limited to: levels of administrative activities, generative or adaptive activities, vision or enabling activities.

In a further use-case scenario, the system 100 may be utilized in the context of an Audience Centered Trusted Feedback PACER Scale. The PACER Scale is a system and method for using electronic devices, computers, software and storage for sensing and gathering distributed data about a focal individual's interpersonal effectiveness in human interactions, human machine interactions and machine to machine interactions. For the purposes of this use-case scenario and other use-case scenarios as appropriate, an individual may be defined to be either human or machine, e.g., but not limited to a robot, a robotic agent, a software agent, artificial intelligence system, or any system that combines human and machine learning algorithms whether implemented is hardware, software or both and whether integrated with human activity or not. The data collected and processed can be analyzed and formatted to provide trusted feedback to the focal individual (e.g. first user 101 and/or second user 110) through electronic media to help the focal individual better understand his or her effectiveness in interactions with their individual colleagues or with an audience of individuals. This feedback may be based upon the reactions of each colleague or audience member who collectively register their personal reactions about the value of the focal individual's interactions with them as experienced from their individual personal vantage point. In certain embodiments, this concept is a departure from a feedback system where a person is simply rating the feedback recipient's actions and behaviors based on the feedback giver's perception of the focal individual in the context of an arbitrary scale such as a Likert scale with five selections from “strongly agree” to “strongly disagree”. In contrast, the PACER indicator registers the reaction of “others” for the perspective of what works for that individual given that individual's responsibilities, knowledge, emotional state, other state, or a combination thereof.

In certain embodiments, the PACER Scale may provide feedback recipients with a perspective of“what worked” for the feedback giver. It is a quantifiable methodology that allows the feedback receiver to gauge what is working along several attributes from the perspective of various members of the audience from their various perspectives, including, but not limited to their perceived engagement in or contribution to the event being monitored. Other attributes may include, but are not limited to preparedness, respectfulness, supportiveness, the use of evidence, clarity of thought, clarity of communications, personal hygiene, authenticity, active-listening, emotional intelligence, leadership, facilitation skills, social skills, organization citizenship behaviors, decisiveness, social skills, creativity, availability, attentiveness, focus, competence along various dimensions including but not limited to digital technologies, other technical areas, industry knowledge, market knowledge, organizational knowledge, management, leadership, or functional areas such as but not limited to marketing, finance, operations, human resources, and/or research and development. One distinction from other methods is that the value of the event, content, or more general context, is also implicitly included in the response. A well delivered argument in favor for an irrelevant topic may score low, for example. The feedback recipient may receive “What Works for Me” feedback from each audience member across a range of specific contribution attributes either individually or in the aggregate and may but not necessarily be anonymous. In an embodiment, which is not limited, the scale might be as follows: If the feedback recipient's presentation or specific contribution attribute worked effectively for the audience member that audience member would indicate so on the system which would be scored by the system as 0 (zero). An indicator scored as 0.5 would let the feedback recipient know that more of the specific contribution attribute would work even better for the audience member. An indicator scored as 1 would let the feedback recipient know that a lot more of the specific contribution attribute would work even better. An indicator scored as −0.5 would let the feedback recipient know that the specific feedback attribute “a bit less than expected” from the audience member's perspective. An indicator scored as −1 would let the feedback recipient know that the specific feedback attribute was “much less than expected” from the audience member's perspective. An indicator of 0 may let the recipient know that their participation “worked for me”, the responding user. In another embodiment, the system 100 may present the first user with an attribute such as but not limited to ‘contribution’ and a list of names of users who were present at the event. One of users that was present may be a second user. To give feedback for that second user, the first user may simply tap the name indicating “works for me”, or the user may swipe right slowly indicting “a little more would be better”, or quickly indicating a “lot more would be better.” As an option, the user may swipe left slowly indicating “kind of didn't work for me” or swipe quickly indicating “really didn't “work for me”. In another embodiment, the user may simply say the words indicated in quotes above.

In certain embodiments, for this use-case scenario or other suitable use-case scenarios, the specific measurable contribution attributes could be but are not limited to, relevance, authenticity, energy, evidence, preparedness, and clarity. In a preferred embodiment, each contribution attribute could, but is not limited to, be prompted to the feedback giver via their electronic device and they will simply: Tap on the user interface screen of the first user device 102 for an indicator of 0 (appreciated and it worked for me). Slow swipe to the right (e.g. on the user interface screen) for an indicator of 0.5 (more of this would work better for me). Fast swipe to the right for an indicator of 1 (a lot more of this would work even better for me). Slow swipe to the left for an indicator of −0.5 (a bit less than expected). Fast swipe to the left for an indicator of −1 (a lot less than expected). A scale such as but not limited to a Likert scale may be used, but not necessarily, to measure engagement and contribution value for the same event, so that the PACER Scale could be calibrated against the engagement and contribution results for determining correlations of specific contribution attributes to engagement and contribution. In certain embodiments, a single user interaction may provide feedback to all users.

An exemplary use case involving the PACER Scale may be as follows: A meeting and/or an event takes place. It is a meeting to discuss progress on Project XYZ. The team leader, Sally, organizes the meeting, manages the logistics, and creates the agenda. The meeting starts at time 0, and Sally calls the meeting to order. There are three presenters and five additional participants in the meeting totaling nine team members. Each team member will have the opportunity to provide their PACER feedback to each of the other eight team members based on their specific reactions to the other team members' engagement and contributions. Through the course of the event or after it is over, each team member will be able to simply tap or swipe on each of the other team members' names or avatars that appear on their device. The six specific contribution attributes will be constantly displayed on the screen for the event participant to tap or swipe according to their reaction to other meeting participants' contributions or engagement.

For example, event participant Joe, while listening to event presenter, Tina, will be able to identify what worked for him based on Tina's presentation. He may tap Relevance which would indicate Tina's presentation was appreciated and “worked for him”. He might believe that the evidence in her presentation “worked for him” but would swipe slowly to the right if he thought some more evidence would work better. As it relates to her Authenticity, Joe may think that Tina was a little less than authentic and might swipe slowly to the left. For Preparedness, Joe thought Tina's Preparedness “worked for him” and would once more tap the Preparedness button. And as far as Clarity goes, Joe thought Tina's presentation was very clear and therefore he would tap the Clarity button “appreciated and worked for me” resulting in the 0 PACER indicator. Finally, even though Joe thought Tina's presentation was clear, relevant, evidence-based, and she came prepared, he thought her energy level was low, and so he swiped slowly to the left which would let Tina know “it was a bit less than expected” for me. Thus, for this Event, Jack PACER vector feedback for Tina would be recorded as: M_{Tina}(Relevance, Authenticity, Energy, Evidence, Preparedness, Clarity)=(0,−0.5,−0.5,0.5,0.5,0,0). The other seven meeting participants would provide their input for Tina, and Tina would be able to receive an aggregate PACER Indicator for this event Y. Tina would also receive team member perception data on both engagement and contribution allowing her to know what areas are working for her audience, what she is doing well, and what she might do more of. The PACER data may be sorted in a variety of ways: per event, over time, by most important audience, and so forth. providing each meeting participant with a variety of avenues to glean what in their contributions have the greatest effect on their team members/audience. Notably, any other use-case scenarios may be utilized with the system 100 and methods as well.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, transmitting queries to users and/or devices to request information and/or feedback associated with other users and/or devices of the system 100; obtaining the requested information from users and/or devices; associating the obtained information with one or more avatars in a virtual social network of the system 100; generating the avatars in the system 100; generating condition state data for the avatars; determining interest state data for users and/or devices of the system 100; generating reports and/or recommendations for users and/or devices to assist the users and/or devices to improve performance at future events; transmitting the reports and/or recommendations to the users and/or devices; conducting machine learning in the system 100; and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100. In certain embodiments, the server 160 may include any number of program modules, which may include software for conduction the various operations performed by the server 160.

Although FIGS. 1-5 illustrates specific example configurations of the various components of the system 100, the system 100 may include any configuration of the components, which may include using a greater or lesser number of the components. For example, the system 100 is illustratively shown as including a first user device 102, a second user device 111, a third user device 115, a computing device 120, a firewall 125, a FFSS 302, a mapping server 304, a sDAASS 306, a CFSS 308, a A&PSS 310 a communications network 135, a server 140, a server 145, a server 150, a server 160, and a database 155. However, the system 100 may include multiple first user devices 102, multiple second user devices 111, multiple third user devices 115, multiple computing devices 120, multiple firewalls 125, multiple FFSSs 302, multiple mapping servers 304, multiple sDAASSs 306, multiple CFSSs 308, multiple A&PSSs 310, multiple communications networks 135, multiple servers 140, multiple servers 145, multiple servers 150, multiple servers 160, multiple databases 155, or any number of any of the other components inside or outside the system 100. Furthermore, in certain embodiments, substantial portions of the functionality and operations of the system 100 may be performed by other networks and systems that may be connected to system 100.

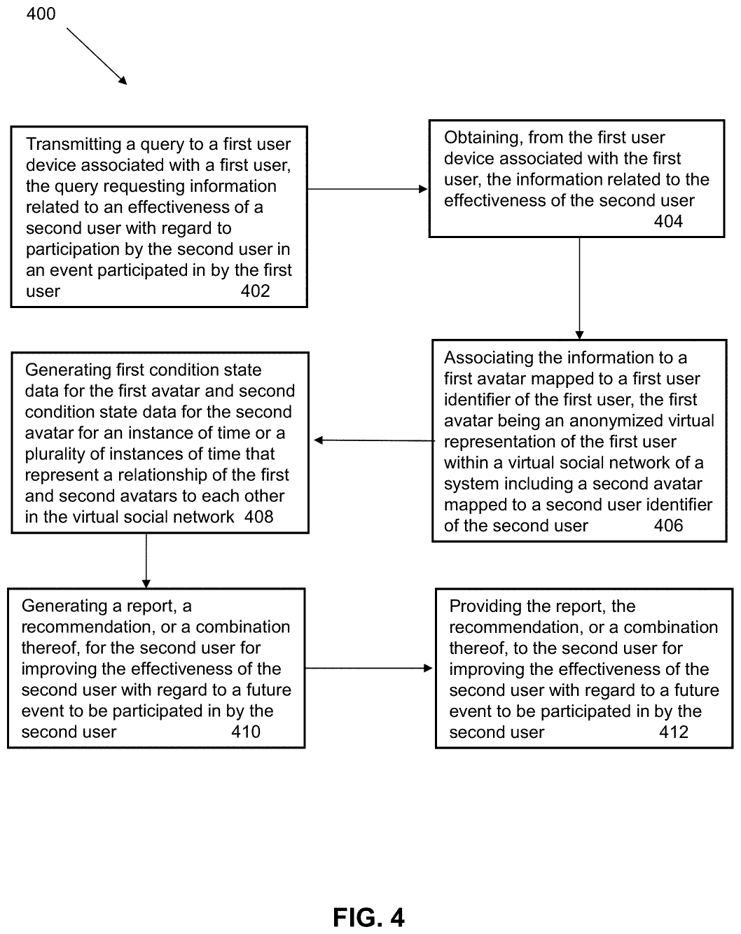

Notably, the system 100 may execute and/or conduct the functionality as described in the method(s) that follow. As shown in FIG. 4, an exemplary method 400 for technology-supported-trusted-performance feedback and experiential learning is schematically illustrated. The method 400 may include steps for obtaining feedback information about users participating in events and for generating reports and/or recommendations to be provided to the users so as to enhance the users' performance at future events. At step 402, the method 400 may include transmitting a query to a first user device 102 associated with a first user (e.g. first user 101) requesting information relating to the effectiveness of a second user (e.g. second user 110) with regard to participation by the second user in an event participated in also by the first user. In certain embodiments, the transmitting of the query may be performed and/or facilitated by utilizing the second user device 111, the wearable device 115, the computing device 120, the FFSS 302, the mapping server 304, the sDAASS 306, the A&PSS 310, the server 140, the server 145, the server 150, the server 160, the communications network 135, the external network 165, any combination thereof, or by utilizing any other appropriate program, network, system, or device.

At step 404, the method 400 may include obtaining, from the first user device 102, the information related to the effectiveness of the second user with regards to participation in the event and/or with regards to anything of interest relating to the second user. In certain embodiments, the obtaining of the information related to the effectiveness of the second user may be performed and/or facilitated by utilizing the first user device 102, the wearable device 115, the computing device 120, the FFSS 302, the mapping server 304, the sDAASS 306, the A&PSS 310, the server 140, the server 145, the server 150, the server 160, the communications network 135, the external network 165, any combination thereof, or by utilizing any other appropriate program, network, system, or device. At step 406, the method 400 may include associating the obtained information to a first avatar mapped to a first user identifier of the first user. In certain embodiments, step 406 may include assigning to the first avatar the ratings or rankings of competences achieved by the first user, which may but would not be limited to competencies such as Transformational Contributor, Autonomous Contributor, Collaborative Contributor, Expert Contributor, Agile Contributor, Organizing Contributor, Authentic Contributor, Transformational Leader, Transactional Leader, Innovation Leader, Creative Leader, Agile Leader, Team Leader, Authentic Leader, Servant Leader, Manager, Director, Executive and so on. In certain embodiments, the first avatar may be an anonymized virtual representation of the first user, such as within a virtual network (e.g. virtual social network) of the system 100. The system 100 may also include a second avatar mapped to a second user identifier of the second user (e.g. second user 110). In certain embodiments, the associated of the obtaining information may be performed and/or facilitated by utilizing the first user device 102, the wearable device 115, the computing device 120, the FFSS 302, the mapping server 304, the sDAASS 306, the A&PSS 310, the server 140, the server 145, the server 150, the server 160, the communications network 135, the external network 165, any combination thereof, or by utilizing any other appropriate program, network, system, or device.

At step 408, the method 400 may include generating first condition state data for the first avatar of the first user and second condition state data for the second avatar of the second user. In certain embodiments, the first condition state data for the first avatar and the second condition state data for the second avatar may be generated for an instance of time or a plurality of instances of time that represent a relationship of the first and second avatars to each other in the virtual network (e.g. virtual social network) of the system 100. In certain embodiments, the generating of the first and/or second condition state data for the first and/or second avatars may be performed and/or facilitated by utilizing the first user device 102, the wearable device 115, the computing device 120, the FFSS 302, the mapping server 304, the sDAASS 306, the A&PSS 310, the server 140, the server 145, the server 150, the server 160, the communications network 135, the external network 165, any combination thereof, or by utilizing any other appropriate program, network, system, or device. Once the first and second condition state date is generated, the method 400 may include, at step 410, generating a report, a recommendation, or a combination thereof, for the second user. The report, the recommendation, or a combination thereof, may include guidance and/or information for enabling and/or facilitating the second user (or another user) to improve the second user's effectiveness with regard to a future event. In certain embodiments, the generation of the report, the recommendation, or a combination thereof, may be performed and/or facilitated by utilizing the first user device 102, the wearable device 115, the computing device 120, the FFSS 302, the mapping server 304, the sDAASS 306, the A&PSS 310, the server 140, the server 145, the server 150, the server 160, the communications network 135, the external network 165, any combination thereof, or by utilizing any other appropriate program, network, system, or device. Once the report, the recommendation, or a combination thereof, are generated, the method 400 may include, at step 412, providing the report, the recommendation, or a combination thereof, to the second user so as to assist the user in improving the effectiveness of the second user with regard to the future event to be participated in by the second user. For example, the report, the recommendation, or a combination thereof, may be transmitted by one or more devices of the system 100 to the second user device 111 of the second user 110. In certain embodiments, the providing of the report, the recommendation, or a combination thereof, may be performed and/or facilitated by utilizing the first user device 102, the wearable device 115, the computing device 120, the FFSS 302, the mapping server 304, the sDAASS 306, the A&PSS 310, the server 140, the server 145, the server 150, the server 160, the communications network 135, the external network 165, any combination thereof, or by utilizing any other appropriate program, network, system, or device. Notably, the method 400 may further incorporate any of the features and functionality described for the system 100, any other method disclosed herein, or as otherwise described herein. In certain embodiments, the reports or recommendations may include but are not limited to including information specific to informing the first or the second user of their ratings or rankings related to the competences the user has achieved or may include but not limited to information about how the user might be able to achieve one or more of various competencies which may but would not be limited to: Transformational Contributor, Autonomous Contributor, Collaborative Contributor, Expert Contributor, Agile Contributor, Organizing Contributor, Authentic Contributor, Transformational Leader, Transactional Leader, Innovation Leader, Creative Leader, Agile Leader, Team Leader, Authentic Leader, Servant Leader, Manager, Director, Executive and so on.

In certain embodiments, another exemplary method may be provided. In this method, the method may include a step of having the user (e.g. first user 101) register and complete a user profile with an application (e.g. FFSS 302) of the system 100 that provides the various functionality and features provided by the system 100. For example, the application may execute on the first user device 102 of the first user 101 and may be visually rendered to the first user via the interface 105 of the first user device 102. Once users register with the application and completes his or her profile, the user may elect to stay logged into the application and keep the application open on the first user device 102. This would enable to the system 100 to continuously interact with other applications, such as, but not limited to, calendar applications, such as Google calendar, GoogleDocs, Office 365, and communications applications, such as Slack, data analysis and visualization applications, such as Excel, messaging systems, GPS mapping systems, and/or any other applications. In certain embodiments, the application may provide screen overlay permission and would enable notifications from the application to interrupt the user's other activities (e.g. such as on the first user device 102 or elsewhere) when it is time to provide or receive feedback.

The method may proceed to include transmitting notifications via the application that would alert the first user 101 to provide feedback about others (e.g. second user 110) for them to learn from. The feedback, for example, may relate to other users' effectiveness, performance, and/or competence at an event that is occurring. The method may then include receiving the feedback from the user about one or more other users via the application. In doing so, the first user 101 may answer queries about the event and about the second user 110 participating with the first user 101 at the event. Once the feedback and/or responses to the queries are entered into the application by the first user 101, the first user 101 may press a submit button (such as via graphical user interface of the application) to cause the data to be transferred securely to the various subsystems of the system 100, such as the sDAASS 306. In certain embodiments, the data may be erased from the first user device 102 once the data is transferred securely to the various subsystems (e.g. FFSS 302, sDAASS 306, CFSS 308, A&PSS 310, etc.) of the system 100. Once the data is received atone or more of the various subsystems, the method may include having one or more of the subsystems aggregating and analyzing the data for the first user 101, the second user 110, any other users, or a combination thereof. The method may then include having the subsystems generate and prepare reports for expert analysis.

In certain embodiments, the method may then include having an expert human and/or machine (e.g. any of the components of the system 100) analyze the reports and identify the condition state of the individual at a point in time and determine appropriate coaching material that would assist the user. The coaching material may, but not necessarily, be included in a recommendation package, which may be a digital file including various information and content for assisting the user to improve performance, effectiveness, and/or competence, such as at future activities and/or events. Once the recommendation package is generated for the second user 110 (and/or other users), the recommendation package may be transmitted by the CFSS 308 to the application executing on the second user device 111 of the second user 110 (or other users as appropriate). The method may also include transmitting a notification to receive feedback to the second user device 111 of the second user 110 as well. The user may confirm that the user wants to receive the feedback via the notification and may receive the feedback or mentoring based upon prior events that have already happened. In certain embodiments, some part of the coaching material may include a use-by-date which may by not necessarily trigger a notification to a user, publisher or other agent, whether human, machine, or some combination to update the material. The prior events may be targeted to improve the user's awareness or in anticipation of upcoming events and a desire to help the user to perform better in the upcoming events. By choosing to receive feedback and advice, the method may include enabling the user to receive recommendations based on the specific experiences of the user as reflected in the feedback comments of others with whom the user has interacted with in the past, including users who are expected to be in the upcoming event. In certain embodiments, the method may include enabling the user to store preferences relating to how the user would like to give and/or provide feedback, such as via the application. The method may then include prompting the user to provide feedback about the advice they received including the question of whether or not the suggested interventions were enacted by the user and if so, their usefulness to the user. Notably, the features and functionality provided by the method may be combined with any of the other features of the other methods and/or systems described in the present disclosure.

The systems and methods disclosed herein may include additional functionality and features. In certain embodiments, the systems and methods may be utilized in conjunction with any type of social media platform and/or system. For example, the functionality provided by the systems and methods may be integrated and/or communicatively linked with a social media application, such as Facebook®. In such embodiments, for example, users may be able to obtain anonymous feedback from a trusted subset of friends about posts the users have made on the social media application and/or events participated in by the users. In certain embodiments, the systems and methods may be utilized in conjunction with online (or augmented real-life) groups using gaming systems and/or applications. For example, the systems and methods may be utilized with a massive online multiplayer game, such as World of Warcraft, wherein gamers (or other users) may obtain anonymous feedback from a trusted subset of their friends relating to their gameplay abilities. In certain embodiments, the systems and methods may be utilized in conjunction with voting systems. In certain embodiments, the systems and methods may be utilized in conjunction with academic programs. For example, the systems and methods may be utilized by students to critique and provided feedback about other students' participation and effectiveness during class projects and/or assignments. In further embodiments, the systems and methods may also be used in other ways. For example, the data gathered and/or generated by the systems and methods can be used for social science studies and for the design of robots or future machine learning and/or artificial intelligence systems. In addition, the data collected via the systems and methods may be used to produce other products, service, devices, compositions or other useful items. For example, the systems and methods may be used, but are not limited to being used, for training purposes in professional academic environments or the data and system may be used to develop simulation exercises for training purposes.

The systems and methods disclosed herein may include further functionality and features. For example, the operative functions of the system 100 and method may be configured to execute on a special-purpose processor specifically configured to carry out the operations provided by the system 100 and method. Notably, the operative features and functionality provided by the system 100 and method may increase the efficiency of computing devices that are being utilized to facilitate the functionality provided by the system 100 and the various methods discloses herein. For example, by training the system 100 over time based on the feedback, data, and/or other information provided and/or generated in the system 100, a reduced amount of computer operations need to be performed by the devices in the system 100 using the processors and memories of the system 100 than compared to traditional methodologies. In such a context, less processing power needs to be utilized because the processors and memories do not need to be dedicated for processing. As a result, there are substantial savings in the usage of computer resources by utilizing the software, techniques, and algorithms provided in the present disclosure. In certain embodiments, various operative functionality of the system 100 may be configured to execute on one or more graphics processors and/or application specific integrated processors. For example, operations associated with the avatars and/or media content operations may be performed on the graphics processors, and, in certain embodiments, as the system 100 learns over time various actions conducted in the system 100, artificial intelligence and/or machine learning algorithms facilitating such learning may also be executed on graphics processors and/or application specific integrated processors.

Notably, in certain embodiments, various functions and features of the system 100 and methods may operate without any human intervention and may be conducted entirely by computing devices. In certain embodiments, for example, numerous computing devices may interact with devices of the system 100 to provide the functionality supported by the system 100. Additionally, in certain embodiments, the computing devices of the system 100 may operate continuously and without human intervention to reduce the possibility of errors being introduced into the system 100. In certain embodiments, the system 100 and methods may also provide effective computing resource management by utilizing the features and functions described in the present disclosure. For example, in certain embodiments, upon receiving feedback and/or other data about the effectiveness of a user in the system 100, any device in the system 100 may transmit a signal to a computing device receiving or processing the feedback and/or other data that only a specific quantity of computer processor resources (e.g. processor clock cycles, processor speed, etc.) may be devoted to processing the feedback and/or other data, and/or any other operation conducted by the system 100, or any combination thereof. For example, the signal may indicate a number of processor cycles of a processor may be utilized to process the feedback, and/or specify a selected amount of processing power that may be dedicated to generating or any of the operations performed by the system 100. In certain embodiments, a signal indicating the specific amount of computer processor resources or computer memory resources to be utilized for performing an operation of the system 100 may be transmitted from the first and/or second user devices 102, 111 to the various components of the system 100.

In certain embodiments, any device in the system 100 may transmit a signal to a memory device to cause the memory device to only dedicate a selected amount of memory resources to the various operations of the system 100. In certain embodiments, the system 100 and methods may also include transmitting signals to processors and memories to only perform the operative functions of the system 100 and methods at time periods when usage of processing resources and/or memory resources in the system 100 is at a selected value. In certain embodiments, the system 100 and methods may include transmitting signals to the memory devices utilized in the system 100, which indicate which specific sections of the memory should be utilized to store any of the data utilized or generated by the system 100. Notably, the signals transmitted to the processors and memories may be utilized to optimize the usage of computing resources while executing the operations conducted by the system 100. As a result, such functionality provides substantial operational efficiencies and improvements over existing technologies.

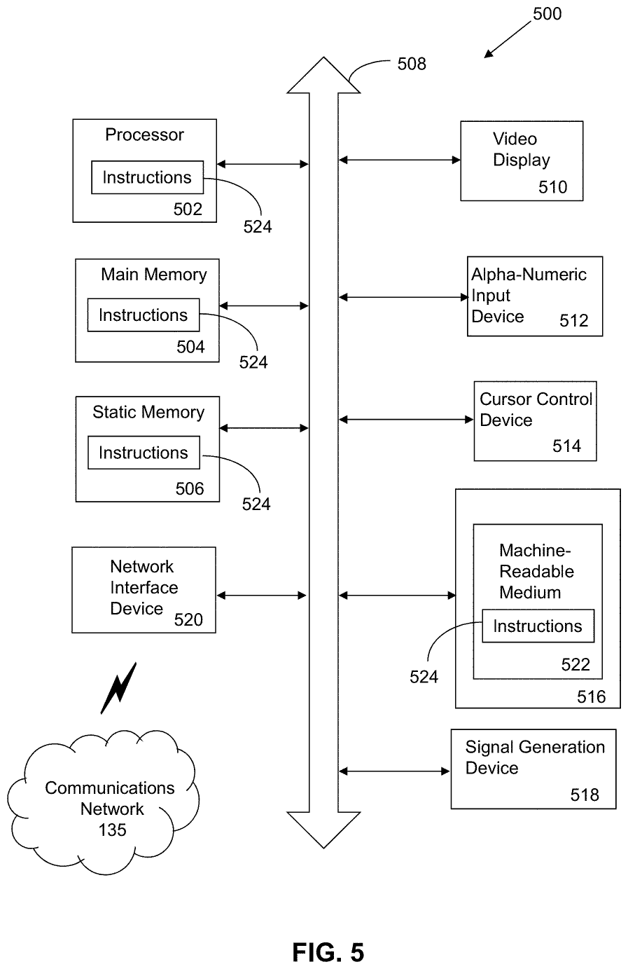

Referring now also to FIG. 5, at least a portion of the methodologies and techniques described with respect to the exemplary embodiments of the system 100 can incorporate a machine, such as, but not limited to, computer system 500, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the third user device 115, the computing device 120, the firewall 125, the server 140, the server 145, the server 150, the database 155, the server 160, the external network 165, the FFSS 302, the mapping server 304, the sDAASS 306, the CFSS 308, the A&PSS 310, any other system, program, and/or device, or any combination thereof. The machine may be connected to any one or more components in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510, which may be, but is not limited to, a liquid crystal display (LCD), a flat panel, a solid state display, or a cathode ray tube (CRT). The computer system 500 may include an input device 512, such as, but not limited to, a keyboard, a cursor control device 514, such as, but not limited to, a mouse, a disk drive unit 516, a signal generation device 518, such as, but not limited to, a speaker or remote control, and a network interface device 520.

The disk drive unit 516 may include a machine-readable medium 522 on which is stored one or more sets of instructions 524, such as, but not limited to, software embodying any one or more of the methodologies or functions described herein, including those methods illustrated above. The instructions 524 may also reside, completely or at least partially, within the main memory 504, the static memory 506, or within the processor 502, or a combination thereof, during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 522 containing instructions 524 so that a device connected to the communications network 135, another network, or a combination thereof, can send or receive voice, video or data, and communicate over the communications network 135, another network, or a combination thereof, using the instructions. The instructions 524 may further be transmitted or received over the communications network 135, another network, or a combination thereof, via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system, comprising:
a memory that stores instructions; and
a processor that executes the instructions to perform operations, the operations comprising:
receiving, from a first user device associated with a first user, information related to effectiveness of a second user with regard to participation by the second user in an event also participated in by the first user;
assigning the information to a first avatar mapped to a first user identifier of the first user, wherein the first avatar is an anonymized virtual representation of the first user within a virtual social network of the system that includes a second avatar mapped to a second user identifier of the second user;
generating, based on an analysis of the information, first condition state data for the first avatar and second condition state data for the second avatar, wherein the first condition state data and the second condition state data are time series variables for an instance of time or a plurality of instances of time that represent an aspect of a relationship of the first and second avatars to each other in the virtual social network of the system; and
providing, based on at least the second condition state data for the second avatar, a report, a notification, a vote, a rank, a recommendation, media, or a combination thereof, to the second user related to a potential for improving the effectiveness of the second user with regard to a future event to be participated in by the second user.

2. The system of claim 1, wherein the information related to the effectiveness of the second user comprises data gathered by a surveillance technology, data associated with transportation, logistics, operations, inventory management or guidance systems, data associated with audio content, data associated with video content, data associated with text analysis, data associated with a global positioning system, data associated with biometric data collection, or a combination thereof.

3. The system of claim 1, wherein the operations further comprise ensuring a privacy of user information associated with the first user, user information generated by the first user, or a combination thereof, wherein the privacy is ensured via confidential computing technology, a trusted execution environment, a system for securing privacy, or a combination thereof.

4. The system of claim 1, wherein the first user, the second user, or both, comprise an intelligent machine, a human, a program, a humanoid, a robot, a drone, a wearable device, an animal, a function, a process, a device, or a combination thereof.

5. The system of claim 1, wherein the event is associated with a plurality of events, or wherein the plurality of events are organized into event types, projects, project types, institutions, institution types, or a combination thereof.

6. The system of claim 1, wherein the operations further comprise providing the information and data associated with the information to a third-party user, wherein the information and data is provide anonymously or not anonymously.

7. The system of claim 6, wherein the third-party user is a subscriber to a plan, an account, or a combination thereof.

8. The system of claim 1, wherein the operations further comprise maintaining a quality of data associated with the information, a quantity of data associated with the information, or a combination thereof, wherein the data is provided to or obtained from the first user, the second user, or a combination thereof.

9. The system of claim 1, wherein the operations further comprise determining an amount of feedback included in the information to determine a quantity of the feedback received, a type of feedback received, or a combination thereof.

10. The system of claim 1, wherein the operations further comprise aggregating the information with other data, and wherein the aggregated information and the other data is provided for use to the first user, the second user, a third user, or a combination thereof.

11. The system of claim 1, wherein the operations further comprise deleting, after assigning the information to the first avatar mapped to the first user identifier, the information from a mapping server utilized to facilitate the assigning of the information to the first avatar.

12. The system of claim 1, wherein the first condition state data further comprises self-assessment or self-development data, a complete or partial history of all events, a representation of a portion of network connections among the first avatar, the second avatar, and other avatars, an avatar identifier, a table of events and event reports, a table of connected avatar identifiers and interaction events, or a combination thereof.

13. The system of claim 1, wherein the operations further comprise processing and projecting the first condition state data onto a first condition state type so as to classify a need of the first user, an interest of the first user, media content to be presented to the first user, a connectivity option to be presented to the first user, or a combination thereof, and/or wherein the operations further comprise processing and projecting the second condition state data onto a second condition state type so as to classify a need of the second user, an interest of the second user, media content to be presented to the second user, or a combination thereof.

14. The system of claim 13, wherein the operations further comprise mapping the first condition state type to a first interest state assigned to the first user, and/or wherein the operations further comprise mapping the second condition state type to a second interest state assigned to the second user.

15. The system of claim 14, wherein the first interest state, the second interest state, or a combination thereof, comprise environmental state variables, organizational state variables, leadership activity variables, behavioral variables, interaction variables, relationship variables, social network variables, communication variables, attitudinal variable, emotional state variables, cognitive state variables, competence variables, knowledge variables, management activity variables, or a combination thereof,

16. The system of claim 1, wherein the operations further comprise utilizing a first secure mapping key to secure a relationship between the first user identifier and the first avatar, and wherein the operations further comprise utilizing a second secure mapping key to secure a relationship between the second user identifier and the second avatar.

17. A method, comprising:
transmitting a query to a first user device associated with a first user, wherein the query requests information related to an effectiveness of a second user with regard to participation by the second user in an event also participated in by the first user;
obtaining, from the first user device associated with the first user, the information related to the effectiveness of the second user with regard to participation by the second user in the event also participated in by the first user;
associating the information to a first avatar mapped to a first user identifier of the first user, wherein the first avatar is an anonymized virtual representation of the first user within a virtual social network of a system that includes a second avatar mapped to a second user identifier of the second user;
generating, based on an analysis of the information, first condition state data for the first avatar and second condition state data for the second avatar, wherein the first condition state data and the second condition state data are time series variables for an instance of time or a plurality of instances of time that represent a relationship of the first and second avatars to each other in the virtual social network of the system; and
providing, based on at least the second condition state data for the second avatar, a report, a vote, a rank, a recommendation, or a combination thereof, to the second user for improving the effectiveness of the second user with regard to a future event to be participated in by the second user.

18. The method of claim 17, further comprising determining, by utilizing a machine or a third user, a relative weighting for the information to be utilized in the analysis.

19. The method of claim 17, wherein the information related to the effectiveness of the second user comprises preparation information associated with the second user, authenticity information, clarify information, evidence information, relevance information, respect information, openness information, contribution information, engagement information, credibility information, value information, any attribute information, any effectiveness information, or a combination thereof.

20. A non-transitory computer-readable device comprising instructions, which when loaded and executed by a processor, cause the processor to perform operations comprising:
generating a query to a first user device associated with a first user, wherein the query requests information related to an effectiveness of a second user with regard to participation by the second user in an event also participated in by the first user;
receiving, from the first user device associated with the first user, the information related to the effectiveness of the second user with regard to participation by the second user in the event also participated in by the first user;
associating the information to a first avatar mapped to a first user identifier of the first user, wherein the first avatar is an anonymized virtual representation of the first user within a virtual social network of the system that includes a second avatar mapped to a second user identifier of the second user;
providing, based on an analysis of the information, first condition state data for the first avatar and second condition state data for the second avatar, wherein the first condition state data and the second condition state data are time series variables for an instance of time or a plurality of instances of time that represent a relationship of the first and second avatars to each other in the virtual social network of the system; and
generating, based on at least the second condition state data for the second avatar, a report, a vote, a rank, a recommendation, or a combination thereof, for the second user for improving the effectiveness of the second user with regard to a future event to be participated in by the second user.
